(19) United States
(12) Patent Application Publication
(10) Pub. No.: US 2026/0142567 A1
(43) Pub. Date: May 21, 2026

(54) TWO-PHASE VOLTAGE REGULATOR MODULE, N-PHASE VOLTAGE REGULATOR MODULE USING SAME, AND MANUFACTURING PROCESS FOR INTEGRATED INDUCTOR ASSEMBLY

(71) Applicant: SHANGHAI METAPWR ELECTRONICS CO., LTD, Shanghai (CN)

(72) Inventors: Mingzhun ZHANG, Shanghai (CN); Xiaoni Xin, Shanghai (CN)

(73) Assignee: SHANGHAI METAPWR ELECTRONICS CO., LTD, Shanghai (CN)

(21) Appl. No.: 19/181,368

(22) Filed: Apr. 17, 2025

(30) Foreign Application Priority Data
Apr. 17, 2024 (CN) 202410464545.1
May 14, 2024 (CN) 202410592808.7

(51) Int. Cl. H02M 3/00; H01F 27/24; H01F 27/29; H01F 41/02; H01F 41/061; H02M 3/155

(52) U.S. Cl. CPC H02M 3/003; H01F 27/24; H01F 27/292; H01F 41/0246; H01F 41/061; H02M 3/155

(57) ABSTRACT

The invention provides a two-phase voltage regulator module, an N-phase voltage regulator module applying the two-phase voltage regulator module and a manufacturing process of the integrated inductor assembly, the two-phase voltage regulator module comprises a top plate assembly, an intermediate assembly and a bottom assembly; the top assembly comprises a top substrate; the intermediate assembly comprises a magnetic core, a first main winding, a second main winding, a first auxiliary winding, a second auxiliary winding, a first auxiliary electrical connector and a second auxiliary electrical connector; and the bottom assembly comprises a first expansion pin and a second expansion pin.

### CROSS-REFERENCE TO RELATED APPLICATION

This application claims the priority benefit of China application serial no. 202410464545.1, filed on Apr. 17, 2024, and China application serial no. 202410592808.7, filed on May 14, 2024. The entirety of the above-mentioned patent application is hereby incorporated by reference herein and made a part of this specification.

### BACKGROUND

### Description of Related Art

In recent years, with the development of technologies such as data centers, artificial intelligence, supercomputers and the like, more and more ASIC with powerful functions are applied, such as a CPU, a GPU, a machine learning accelerator, a network switch, a server and the like, which consume a large amount of current, for example, reach thousands of amperes, and the power demand thereof rapidly fluctuates. A multi-phase voltage regulator module (VRM) is conventionally used to supply such a load. In order to meet the requirement that the load current is continuously increased and the bandwidth is continuously improved, the phase number of the VRM and the capacitance value of the output decoupling capacitor of the VRM are increased. The mode improves the transient response of the traditional VR to a certain extent; however, due to the large output impedance, the space occupied by the decoupling capacitor and the distance between the decoupling capacitor and the load and other factors, the performance limit of the traditional VRM in the aspect of transient response is achieved. Other techniques for improving conventional VR, such as increasing switching frequency and/or reducing inductance, improve transient response, but at the expense of efficiency reduction. The anti-coupling inductor technology has relatively low leakage inductance, and therefore has relatively high transient response; meanwhile, the anti-coupling inductor has relatively high steady-state equivalent inductance, so that the efficiency is improved; and the anti-coupling inductor technology can meet the requirement of transient performance and improve the efficiency, so that the anti-coupling technology is a hot spot designed by the VRM. However, the multi-phase coupling inductor comprises a plurality of windings, and the plurality of windings need to be coupled to each other, so that the manufacturing difficulty is high, and the application is not flexible enough. The Trans-Inductor Voltage Regulator (TLVR) technology can couple multiple mutually independent inductors together through the auxiliary winding so as to solve the difficulty in manufacturing the multi-phase coupling inductor.

The invention mainly provides different structures and coupling modes of a main winding and an auxiliary winding in a series of TLVR inductors, and a method for realizing multi-phase coupling TLVR inductance through a plurality of two-phase integrated TLVR inductors. Furthermore, the invention further provides a two-phase integrated TLVR inductor structure and an implementation method thereof.

### SUMMARY

In view of the above, one of the objectives of the invention is to provide a two-phase voltage regulator module, comprising a top plate assembly, a middle assembly and a bottom substrate assembly;
the top plate assembly comprises a top substrate;
the middle assembly comprises a magnetic core, a first main winding, a second main winding, a first auxiliary winding, a second auxiliary winding, a first auxiliary electrical connector and a second auxiliary electrical connector; the middle assembly further comprises a top surface and a bottom surface which are opposite to each other, a first side surface and a third side surface which are opposite to each other, and a second side surface and a fourth side surface which are opposite to each other, wherein each of the first side surface, the second side surface, the third side surface and the fourth side surface is arranged between the top surface and the bottom surface;
the first main winding and the first auxiliary winding are adjacently arranged, and the first main winding and the first auxiliary winding are electrically isolated; the second main winding and the second auxiliary winding are adjacently arranged, and the second main winding and the second auxiliary winding are electrically isolated; the first main winding, the second main winding, the first auxiliary winding and the second auxiliary winding both comprise a top surface bonding pad arranged on the top surface and a bottom surface bonding pad arranged on the bottom surface; and the first auxiliary electrical connector and the second auxiliary electrical connector both comprise top pins arranged on the top surface and bottom pins arranged on the bottom surface;
the bottom substrate assembly comprises a first extension pin and a second extension pin;
the first auxiliary winding and the first auxiliary electrical connector are electrically connected through a top surface bonding pad, the top pins and a top substrate; the second auxiliary winding and the second auxiliary electrical connector are electrically connected through the top surface bonding pad, the top pins and the top substrate; the first auxiliary winding and the second auxiliary electrical connector are electrically connected through the bottom surface bonding pad, the bottom pins and the bottom substrate assembly; the bottom pins of the first auxiliary electrical connector is electrically connected with the first expansion pin; and the bottom surface bonding pad of the second auxiliary winding is electrically connected with the second expansion pin.

Preferably, the structures of the first main winding, the second main winding, the first auxiliary winding and the second auxiliary winding are the same; and the cross sections areas of the first auxiliary winding and the second auxiliary winding are smaller than the sectional areas of the first main winding and the second main winding.

Preferably, the magnetic core comprises two main winding limiting holes and two auxiliary winding limiting holes, and the main winding limiting holes and the auxiliary winding limiting holes both penetrate through the top surface and the bottom surface; the main winding limiting hole is used for accommodating a main winding, and the auxiliary winding limiting hole is used for accommodating an auxiliary winding; air gaps are formed between each of the main winding limiting holes and an adjacent auxiliary winding limiting hole; and the main first and second windings and the first and second auxiliary windings are I-shaped.

Preferably, the magnetic core comprises two winding limiting holes, and each of the winding limiting holes penetrates through the top surface and the bottom surface; and each of the winding limiting holes is used for containing a main winding and an auxiliary winding.

Preferably, the first auxiliary electrical connector and the second auxiliary electrical connector are arranged close to the first side face of the magnetic core.

Preferably, the two-phase voltage regulator module further comprises two switch units, switch (SW) pins of each of the switch units is disposed adjacent to a first side surface of the two-phase voltage regulator module, and top surface pads of the first main winding and the second main winding are disposed adjacent to a first side surface of the magnetic core;
the two-phase voltage regulator module further comprises a first power electrical connector and two second power electrical connectors, the first power electrical connector is arranged adjacent to the first side face of the magnetic core, and the two second power electrical connectors are arranged on the second side face of the magnetic core and the fourth side face of the magnetic core respectively.

Preferably, the first power electrical connector is arranged between the first auxiliary electrical connector and the second auxiliary electrical connector.

Preferably, the two first power electrical connectors are arranged on the two sides of the first auxiliary electrical connector and the two sides of the second auxiliary electrical connector respectively; and the first auxiliary electrical connector and the second auxiliary electrical connector are coupled.

Preferably, the two-phase voltage regulator module further comprises an input capacitor and other passive elements, wherein the input capacitor is arranged between the two switch units and is arranged adjacent to the first side face; and the other passive elements are arranged adjacent to the third side face.

Preferably, the two-phase voltage regulator module further comprises an input capacitor and other passive elements, wherein the input capacitor is arranged between the two switch units and is arranged adjacent to the third side face; and the other passive elements are arranged between each of the switch units and the input capacitor arranged adjacent to the third side face.

Preferably, the middle assembly further comprises limiting grooves, and the limiting grooves are arranged adjacent to the first side face, the second side face and/or the fourth side face; and the two-phase voltage regulator module is used for containing a first power electrical connector, a first auxiliary connecting piece, a second auxiliary connecting piece and a second power electrical connector.

Preferably, the limiting groove is formed in a side surface of one of the first side face, the second side face and the fourth side face.

Preferably, each limiting groove extends from the side face to the top face and the bottom face of the middle assembly.

Preferably, each of the limiting grooves formed in the first side face are connected together to form a side wall groove; and the first power electrical connector, the first auxiliary electrical connector and the second auxiliary electrical connector copper column insulating material are connected into a connecting piece assembly.

Preferably, the limiting grooves are formed in the top surface and the bottom surface of the middle assembly.

Preferably, the first auxiliary connecting piece, the second auxiliary connecting piece and the second power electrical connector are C-shaped, □-shaped or strip-shaped.

Preferably, chamfering treatment is carried out on the limiting groove used for setting the first and second power electrical connectors and an edge of the power electrical connector.

Preferably, wherein the main winding and the auxiliary winding in the same limiting hole have the same width, and the thickness of the main winding is greater than the thickness of the auxiliary winding.

Preferably, the main winding and the auxiliary winding are I-shaped; the sectional areas of the main winding and the auxiliary winding are square; and the main winding and the auxiliary winding are enameled copper flat wires.

Preferably, the main winding and the auxiliary winding are round enameled wires.

Preferably, a glue dispensing hole position is formed in one side of the limiting hole; the glue dispensing hole position extends to a certain depth from the top surface of the magnetic core; and the glue dispensing hole position is used for arranging a glue material and fixing the main winding, the auxiliary winding and the magnetic core together.

Preferably, a chamfer is arranged on the side, adjacent to the auxiliary winding, of the main winding on the top surface and/or the bottom surface of the middle assembly.

Preferably, the first main winding and the second main winding are in a Z shape; the first auxiliary winding and the second auxiliary winding are n-shaped; the first ends of the first main winding and the second main winding are arranged close to the first side face, and the second ends are arranged close to the third side face; and the first auxiliary winding and the second auxiliary winding are arranged between the first main winding and the second main winding.

Preferably, the first main winding and the second main winding are both formed by bending or stamping enameled insulating copper flat wires.

Preferably, the magnetic core comprises a first magnetic core, a second magnetic core and a third magnetic core; and the first magnetic core and the second magnetic core comprise grooves which are respectively used for limiting the first main winding, the first auxiliary winding, the second main winding and the second auxiliary winding.

Preferably, the first magnetic core and the second magnetic core both comprise limiting grooves used for assembling the second power electrical connector.

Preferably, the first end and the auxiliary winding of the main winding are exposed in air adjacent to the first side surface of the magnetic core.

Preferably, the bottom surface of the intermediate assembly comprises a groove or a step for accommodating an output capacitor; and the output capacitor is electrically connected with the bottom substrate assembly.

Preferably, the magnetic core is integrally formed or assembled; and the magnetic core material can be a powder core magnetic core or a ferrite material.

Preferably, the bottom assembly comprises top surface pins and bottom surface pins; the top surface pins comprise an input positive pin, a grounding pin, a signal pin, an output positive pin, an auxiliary winding pin and an auxiliary part pin; and the top surface pins of the bottom assemblies are in one-to-one correspondence with and electrically connected with the positions of the bottom pins of the middle assembly.

Preferably, each of the bottom surface pins comprises a signal pin, an input positive pin, a function extension pin, an output positive pin and a grounding pin; and the output positive pin and the grounding pin are arranged in a staggered mode.

Preferably, the two-phase voltage regulator module further comprises a vertical plate, and the vertical plate is arranged adjacent to the third side face of the middle assembly; the vertical plate comprises a signal electrical connector and a large-area copper layer; and the large-area copper layer is arranged between the signal electrical connector and the magnetic core.

Preferably, the first main winding and the second main winding are not coupled.

Preferably, the coupling between the main winding and the adjacent auxiliary winding is strong coupling or weak coupling.

Preferably, the first/second power electrical connectors and the first/second auxiliary electrical connectors are formed by stamping a copper sheet, electroplating a layer of nickel on the copper sheet and then electroplating a layer of tin.

Preferably, a layer of copper is electroplated on the copper sheet between the copper sheet stamping and nickel electroplating.

An N-phase voltage regulation module, characterized by comprising N2 two-phase voltage regulation modules, wherein N is an even number; each of the two-phase voltage regulation modules is arranged on the same load mainboard, and the first expansion pins of one two-phase voltage module and the second expansion pins of the other two-phase voltage module are sequentially and electrically connected in series to form an auxiliary winding loop.

Preferably, the auxiliary winding loop further comprises a compensation inductor, and the compensation inductor is connected in series between the first expansion pin of any of the two-phase voltage regulation modules and the second expansion pin of the other two-phase voltage module.

A manufacturing process is used for manufacturing an inductor integrated assembly which comprises a magnetic core, a first main winding, a second main winding, a first auxiliary winding, a second auxiliary winding, a power electrical connector and an auxiliary electrical connector. The manufacturing process comprises the following steps:
Step 1, pressing a magnetic powder core material into a magnetic core, wherein the magnetic core comprises a winding positioning hole, a groove or a limiting groove; annealing the magnetic core;
Step 2, carrying out flat wire cutting or stamping on the enameled copper, and manufacturing a main winding and an auxiliary winding; then bonding one main winding and one auxiliary winding with glue;
Step 3, combining the magnetic core formed in the step 1 and the step 2 to form a winding, so as to form an integrated inductor semi-finished product;
Step 4, performing impregnation treatment on the integrated inductor semi-finished product obtained in step 3;
Step 5, grinding the top surface and the bottom surface of the inductor semi-finished product obtained in the step 4, so that the heights of the winding on the top surface and the bottom surface protruding out of the magnetic core are equal.

Preferably, the surface coating process is carried out on the inductance semi-finished product formed in the step 5; and then the coating.

An inductor assembly comprises: a magnetic core, a first main winding, a second main winding, a first auxiliary winding, a second auxiliary winding, a first auxiliary electrical connector and a second auxiliary electrical connector; wherein the inductor assembly further comprises a top surface and a bottom surface which are opposite to each other, a first side surface and a third side surface which are opposite to each other, and a second side surface and a fourth side surface which are opposite to each other, wherein each side surface is arranged between the top surface and the bottom surface.

The first main winding and the first auxiliary winding are adjacently arranged, and the first main winding and the first auxiliary winding are electrically isolated; the second main winding and the second auxiliary winding are adjacently arranged, and the second main winding and the second auxiliary winding are electrically isolated; the first main winding, the second main winding, the first auxiliary winding and the second auxiliary winding both comprise a top surface bonding pad arranged on the top surface and a bottom surface bonding pad arranged on the bottom surface; and the first auxiliary electrical connector and the second auxiliary electrical connector both comprise a top pin arranged on the top surface and a bottom pin arranged on the bottom surface.

The inductor assembly further comprises a first power electrical connector and two second power electrical connectors. The first power electrical connector is arranged adjacent to the first side surface of the magnetic core, and the two second power electrical connectors are arranged on the second side surface of the magnetic core and the fourth side surface of the magnetic core respectively.

The inductor assembly further comprises a limiting groove. The limiting groove is arranged adjacent to the first side surface, the second side surface and/or the fourth side surface; and the two-phase voltage regulator module is used for accommodating the first power electrical connector, the first auxiliary electronic connector, a second auxiliary electronical connector and a second power electrical connector.

The limiting grooves formed in the first side surface are connected together to form a side wall groove; and the first power electrical connector, the first auxiliary electrical connector and the second auxiliary electrical connector are connected into a connector assembly through insulating material.

Chamfering treatment is carried out on the limiting groove used for setting the first and second power electrical connector and the edge of the power electrical connector; a chamfer is arranged on the side, adjacent to the first/second auxiliary winding and the first/second main winding on the top surface and/or the bottom surface of the inductor assembly.

The magnetic core comprises two winding limiting holes, and each of the winding limiting holes penetrates through the top surface and the bottom surface; and each of the winding limiting holes is used for containing a main winding and an auxiliary winding.

The main winding and the auxiliary winding in the same limiting hole have the same width, and a thickness of the main winding is greater than a thickness of the auxiliary winding.

A glue dispensing hole position is formed in one side of the limiting hole; the glue dispensing hole position extends to a certain depth from the top surface to the inner of the magnetic core; and the glue dispensing hole position is used for arranging a glue material and fixing the main winding, the auxiliary winding and the magnetic core together.

The bottom surface of the inductor assembly comprises a groove or a step for accommodating an output capacitor.

The first main winding and the second main winding are in ”Z” shape; the first auxiliary winding and the second auxiliary winding are “n” shaped; the first ends of the first main winding and the second main winding are arranged close to the first side surface, and the second ends are arranged close to the third side surface; and the first auxiliary winding and the second auxiliary winding are arranged between the first main winding and the second main winding.

The main winding and the auxiliary winding are “I” shaped; sectional areas of the main winding and the auxiliary winding are square or circle.

Compared with the prior art, the application has the following beneficial effects:
(1) According to the invention, the top surface bonding pad is arranged on the top surface of the intermediate assembly of the main winding and used for being connected with the switch unit, and the bottom surface bonding pad is arranged on the intermediate assembly and used for being connected with the load, that is, the TLVR technology is realized in the bonding pads of the inductor respectively arranged on the opposite sides of the intermediate assembly. While better dynamic performance is obtained through the TLVR technology, the thermal resistance of the VRM module is reduced, the heat dissipation capacity of the VRM module is enhanced, and the power density of the VRM module is further improved.
(2) Through the TLVR technology, the non-coupled multi-phase inductor in the plurality of VRM modules or the plurality of discrete inductors have mutually coupled functions; the dynamic inductance of the multiphase VRM module is reduced to meet the requirement of rapid change of the load current; and on the other hand, the multi-phase inductor coupling characteristic is realized through the TLVR technology, and the manufacturing difficulty of a traditional multiphase coupling inductor is reduced.
(3) According to the invention, the coupling characteristic of the multiphase inductor is realized through the two-phase integrated TLVR inductor, so that the manufacturing difficulty of a traditional multiphase coupling inductor is difficult, and the application mode is more flexible.
(4) The output capacitor is arranged on the top surface of the bottom substrate, and the bottom surface of the magnetic core is provided with a groove or a step for accommodating the output capacitor, so that the output capacitor is arranged adjacent to the output end, and the dynamic performance of the VRM module is improved.

### BRIEF DESCRIPTION OF THE DRAWINGS

FIG. 1A to FIG. 1E are circuit topological diagrams of a multi-phase voltage regulator module.

FIG. 2A to FIG. 2E are schematic structural diagrams of Embodiment 1 of a voltage regulator module.

FIG. 3A to FIG. 3F are schematic structural diagrams of Embodiment 2 of a voltage regulator module.

FIG. 4A to FIG. 4F are schematic structural diagrams of Embodiment 3 of a voltage regulator module.

FIG. 5A to FIG. 5J are a manufacturing process flow of a voltage regulator module.

FIG. 6A to FIG. 6C are schematic structural diagrams of another embodiment of a voltage regulator module.

FIG. 7A to FIG. 7E are schematic structural diagrams of Embodiment 6 of a voltage regulator module.

FIG. 8A to FIG. 8E are schematic structural diagrams of Embodiment 7 of a voltage regulator module.

### DESCRIPTION OF THE EMBODIMENTS

According to the two-phase voltage regulator module, the two-phase voltage regulator module has the coupling characteristic through the TLVR technology, so that the voltage regulator module VRM achieves better dynamic performance. Meanwhile, the switch unit on the top surface is closer to the radiator, the heat dissipation capacity of the VRM module is enhanced, and the power density of the VRM module is improved.

The invention further provides a multi-phase voltage regulator module applying the two-phase voltage regulator module.

The technical solutions in the embodiments of the present disclosure will be clearly and completely described below with reference to the accompanying drawings in the embodiments of the present disclosure. All other embodiments obtained by a person of ordinary skill in the art based on the embodiments of the present invention without creative efforts shall fall within the protection scope of the present invention.

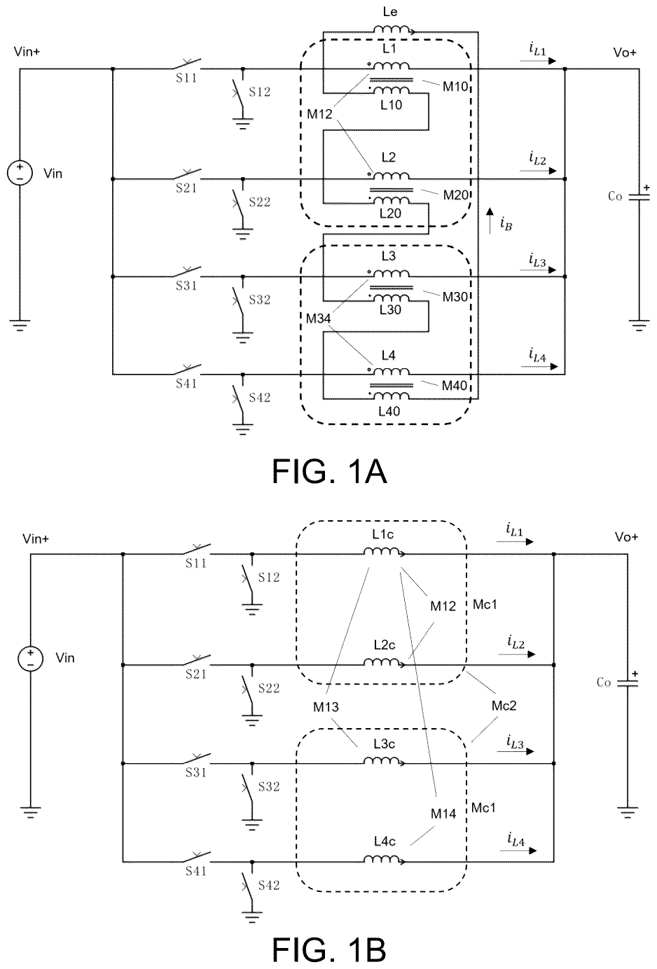

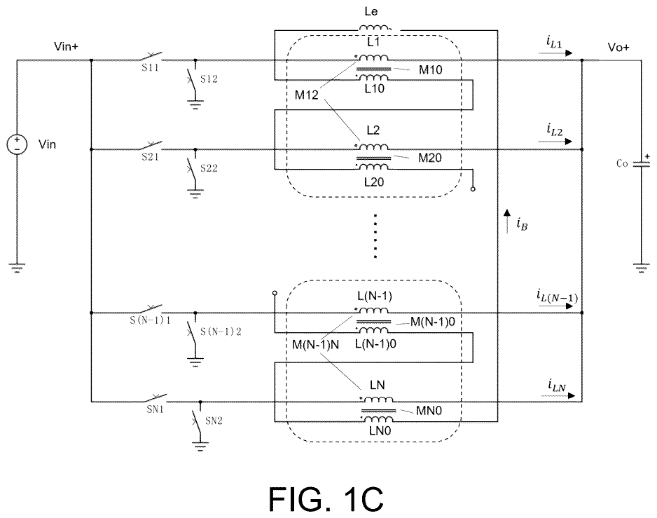

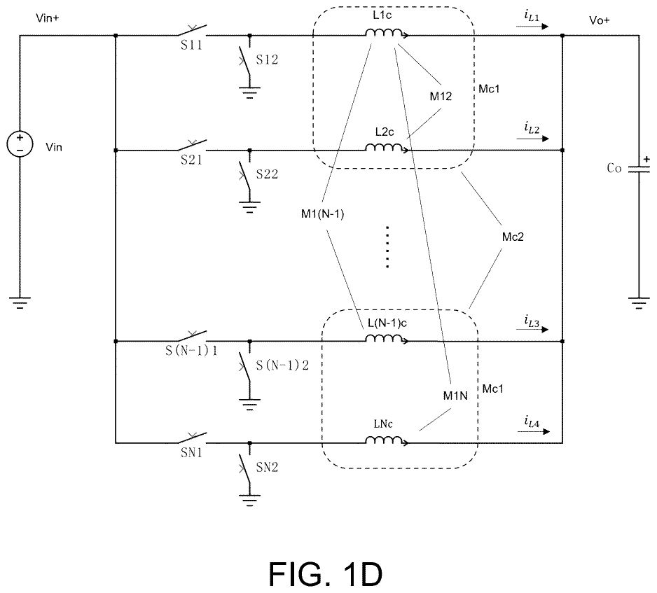

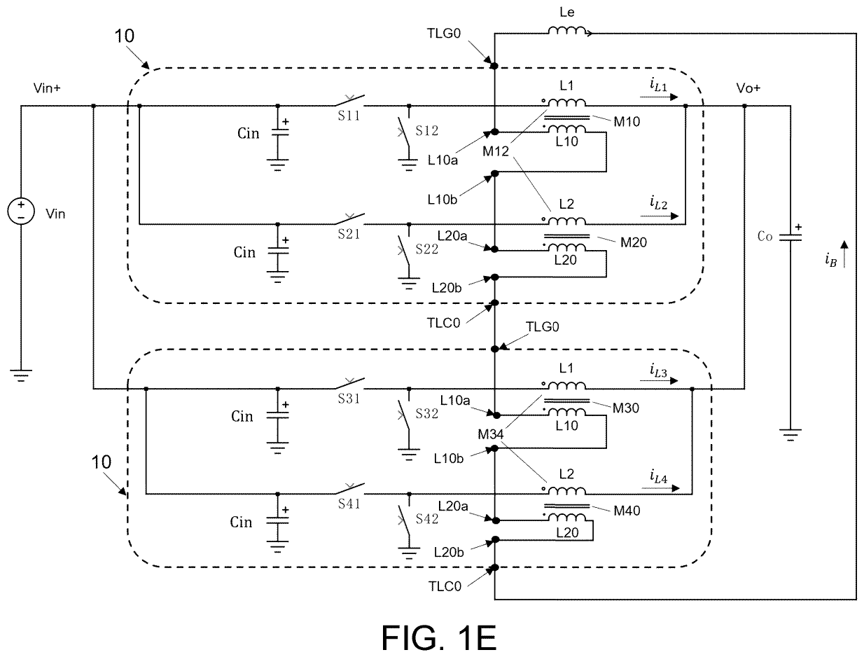

FIG. 1A is a circuit schematic diagram of a TLVR technology. As shown in FIG. 1A, main inductors L1, L2, L3 and L4 are four independent inductors with no coupling relationship with each other, and auxiliary windings L10, L20, L30 and L40 are respectively coupled with main inductors L1, L2, L3 and L4, auxiliary windings L10, L20, L30 and L40 can be directly connected end to end to form an auxiliary winding loop, and an external compensation inductor Le can be additionally arranged in a loop of the auxiliary winding; so that four independent main inductors L1, L2, L3 and L4 which do not have a coupling relationship with each other are equivalent to four anti-coupling inductors having a coupling relationship between any two phases shown in FIG. 1B.

FIG. 1C and FIG. 1D are a circuit diagram and an equivalent circuit diagram (N is an even number) of an N-phase TLVR technology, and the principle is the same as the four-phase TLVR circuit shown in FIG. 1A and FIG. 1B. A two-phase integrated TLVR inductor is shown in each dotted line frame, so that the N-phase TLVR inductor comprises N/2 two-phase integrated TLVR inductors, and the N/2 two-phase integrated TLVR inductors are connected in series.

FIG. 1E shows a four-phase VRM circuit topology including two two-phase integrated TLVR inductors. Each dashed box in the figure is shown as a two-phase VRM module 10, and each two-phase VRM module 10 comprises a two-phase integrated TLVR inductor. Expansion pins TLG0 and TLC0 (equivalent to a first auxiliary winding external connection pad and a second auxiliary winding external connection pad) are auxiliary windings in the VRM module and are used for realizing the pins of the TLVR function, TLG0 and TLC0 of the plurality of VRM modules are connected in series on the load main board, and the multi-phase TLVR technology can be realized.

### Embodiment 1

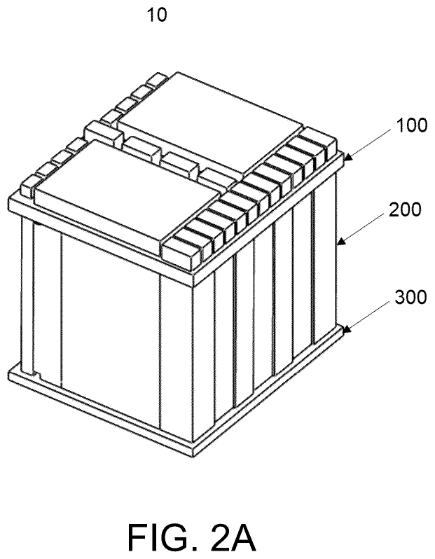

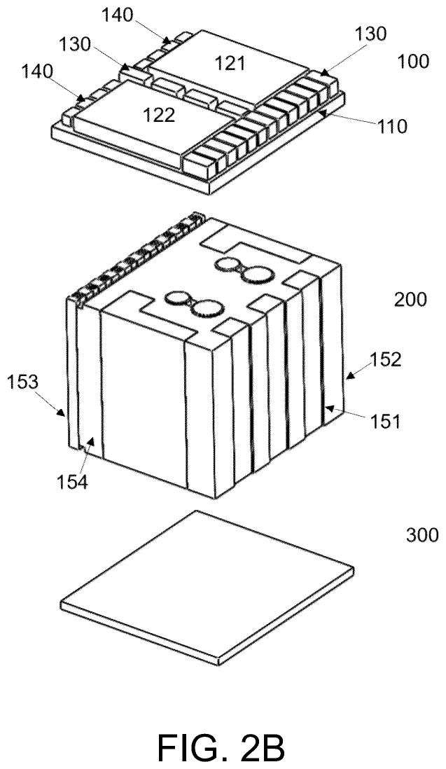

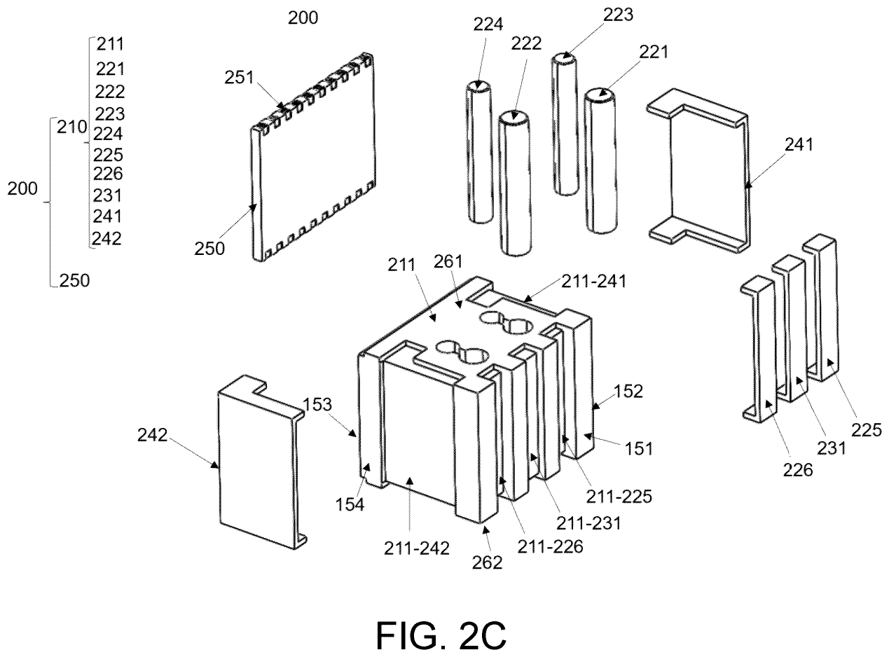

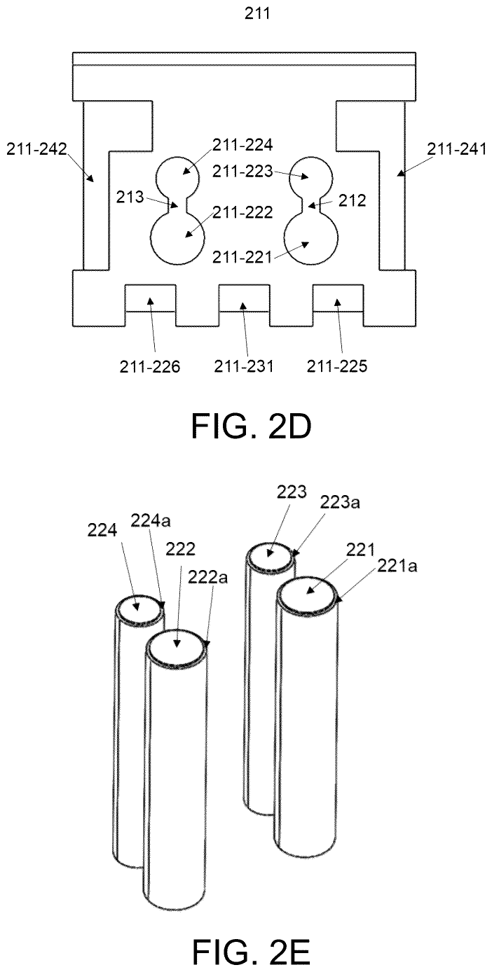

FIGS. 2A-2E disclose a structure of a VRM module 10 that applies the circuit topology shown in FIG. 1E. FIG. 2B is a structural exploded view of the VRM module 10. The VRM module 10 comprises a top assembly 100, an intermediate assembly 200 and a bottom assembly 300. The top assembly 100 comprises a top substrate 110, a first switch unit 121, a second switch unit 122, an input capacitor 130 and other passive elements 140. The top substrate 110 comprises an upper surface 111 and a lower surface 112 which are opposite to each other. The VRM module 10 comprises a first side surface 151, a second side surface 152, a third side surface 153 and a fourth side surface 154, wherein the first side surface 151 and the third side surface 153 are opposite to each other, and the second side surface 152 is opposite to the fourth side surface 154. The definition of the first side surface, the second side surface, the third side surface and the fourth side surface herein is also the side surface definition of the top substrate 110, the intermediate assembly 200 and the bottom assembly 300.

The first switch unit 121 and the second switch unit 122 are disposed in the middle of the top substrate 110, the SW pin of each switch unit is disposed adjacent to the first side surface 151 of the top substrate 110, and the signal pin of each switch unit is disposed adjacent to the third side surface 153 of the top substrate 110. The input capacitor 130 is disposed adjacent to the first side surface 151 of the top substrate 110, or between two switch units. Other passive elements 140 are disposed adjacent to the third side surface 153 of the top substrate 110. In this way, the path of the power loop in the VRM module 10 can be the shortest, so that the conversion efficiency of the VRM module is improved; and meanwhile, the path of the signal loop in the VRM module is also the shortest, so that the anti-interference capability of the signal loop is improved.

FIG. 2C is a structural exploded view of the intermediate assembly 200 shown in FIG. 2B; and FIG. 2D is a top view of the magnetic core 211 shown in FIG. 2C. As shown in FIG. 2C, the intermediate assembly 200 comprises an integrated inductor 210 and a vertical plate 250, wherein the integrated inductor 210 comprises a magnetic core 211, a first main winding 221, a second main winding 222, a first auxiliary winding 223, a second auxiliary winding 224, a first power electrical connector 231, a second power electrical connector 241/242, a first auxiliary electrical connector 225 and a second auxiliary electrical connector 226.

The plane where the top surface of the magnetic core 211 is located is a top surface 261, and the plane where the bottom surface is located is a bottom surface 262. The magnetic core 211 is provided with a main winding limiting hole 211-221/211-222 and an auxiliary winding limiting hole 211-223/211-224. In the embodiment, the horizontal cross sections of the winding limiting holes are circular. The magnetic core 211 is provided with a limiting groove of an electrical connector, such as a limiting groove 211-231 of the first power electrical connector, a limiting groove 211-241/211-242 of the second power electrical connector, and a limiting groove 211-225/211-226 winding limiting hole of the auxiliary electrical connector, so as to ensure reliable electrical isolation between the main winding and the auxiliary winding. The limiting groove of the power electrical connector is beneficial to the pin position precision and the bonding pad flatness of the power electrical connector. Preferably, the limiting groove and the edge of the power electrical connector need to be chamfered, and the chamfers play a role in guiding during assembly (not shown in the figure).

In the embodiment, the main winding 221/222 and the auxiliary winding 223/224 are all “I” shaped enameled insulating round copper wires, but are not limited thereto. Because the current flowing through the main winding is large, the diameter of the main winding is larger than that of the auxiliary winding, so that the direct-current impedance of the winding is reduced, and the conversion efficiency of the VRM module is improved. The main winding and the auxiliary winding both penetrate through the top surface 261 and the bottom surface 262 of the magnetic core. Electrical isolation needs to be achieved between the main winding and the auxiliary winding; and in order to ensure the reliable implementation of electrical isolation, a certain distance is formed between the main winding limiting hole and the auxiliary winding limiting hole; and on the other hand, in order to maintain the coupling coefficient between the main winding and the auxiliary winding, air gaps 212 and 213 are arranged between the main winding limiting hole and the auxiliary winding limiting hole, so that the magnetic flux generated by the current in the main winding and the magnetic flux generated by the current in the auxiliary winding can be fully coupled.

FIG. 2E is a schematic structural diagram of the winding in FIG. 2C. As shown in FIG. 2E, the main winding 221/222 and the auxiliary winding 223/224 are both made of enameled insulated copper wires, 221a, 222a, 223a and 224a wrapped outside the winding are insulating paint films, and are used for realizing electrical isolation between the main winding and the auxiliary winding.

The main windings 221 and 222 are disposed adjacent to the first side surface 151 of the magnetic core 211. The auxiliary windings 223 and 224 are respectively disposed between the main winding 221/222 and the third side surface 153 of the magnetic core. The first power electrical connector 231 is arranged in the middle of the first side surface 151 of the magnetic core, the second power electrical connector 241/242 is arranged on the second side surface 152 and the fourth side surface 154 of the magnetic core respectively. The second power electrical connector 241/242 is “□” shape of the top view and corresponds to the shape of the limiting grooves 211-241/211-242 on the magnetic core, so that alignment during automatic assembly is facilitated. The first auxiliary electrical connector 225 and the second auxiliary electrical connector 226 are disposed on a first side surface 151 of the magnetic core and are disposed on two sides of the first electrical connector 231.

In the embodiment, preferably, the first power electrical connector 231, the second power electrical connector 241/242 and the auxiliary electrical connector 225/226 are formed by stamping a copper sheet and are subjected to electroplating treatment after the required shape is stamped. In the general electroplating process, a layer of nickel is electroplated firstly, and then a layer of tin is electroplated to ensure that the bonding pad of the electrical connector is not oxidized. Furthermore, in some cases, due to the fact that certain surfaces of the cut copper sheets are uneven, one layer of copper is electroplated before the nickel layer and the tin layer are electroplated, so that the surface of the copper sheet is ensured to be sufficiently flat, and the plating quality of the electroplated nickel and tin in the electroplating process is improved. In the assembling process, the power electrical connector and the winding are assembled with the magnetic core 211 together through glue. In the embodiment, on one hand, through the arrangement mode of the first electrical connector and the second electrical connector, direct-current impedance minimization of the power loop can be achieved; meanwhile, the high-frequency parasitic inductance of the power loop is ensured to be maximized, and the resonance point of resonance oscillation between the high-frequency parasitic inductance and the input capacitor of the input power loop is avoided, so that efficient and reliable work of the VRM module is ensured. On the other hand, through the arrangement of the auxiliary electrical connector, the high coupling coefficient between the auxiliary winding loop and the main winding loop is ensured, the technical effect of TLVR is improved, the magnitude of dynamic sensing is reduced, and the dynamic performance of the VRM module is improved.

In each two-phase integrated inductor, the first main winding 221 and the first auxiliary winding 223 form a first-phase inductor, and the second main winding 222 and the second auxiliary winding 224 form a second-phase inductor. The first-phase inductor and the second-phase inductor are both arranged in the magnetic core 211, and a magnetic material is arranged between the two-phase inductors. The magnetic fluxes generated by the current flowing through the first main winding 221 and the second main winding 222 are decoupled through the magnetic material between the two inductors. Therefore, the first-phase inductor and the second-phase inductor are mutually independent two-phase inductors, that is, the first main winding 221 and the second main winding 222 are not coupled with each other, that is, the coupling coefficient between the first main winding 100 and the second main winding 200 is close to 0. (The coupling coefficient between the first main winding 100 and the second main winding 200 is smaller than 0.2, and it is considered that the two windings are approximately non-coupled).

For an N-phase inductor (where N is an even number), when N/2 of the two-phase integrated inductors (as shown in FIG. 2A) are connected according to the schematic in FIG. 1E, and an external compensation inductor (Le) is added to form an auxiliary winding loop, an equivalent N-phase anti-coupling inductor (as depicted in FIG. 1D) is achieved. This configuration implements an N-phase VRM (Voltage Regulator Module) with Trans-Inductor Voltage Regulator (TLVR) technology, meeting the requirements for both dynamic performance and steady-state efficiency in VRM applications.

Vertical plate 250 includes signal electrical connectors 251. The vertical plate 250 is arranged adjacent to the third side surface 153 of the magnetic core and positioned away from the power electrical connectors to prevent interference noise from the power loop from coupling into the signal electronical connectors, thereby ensuring stable operation of the VRM module. Additionally, the vertical plate 250 incorporates a large-area copper layer located between the signal electronical connectors 251 and the magnetic core 211. This copper layer can be connected to the power ground terminal, though it may also remain unconnected. In this embodiment, the copper layer functions as an EMI shielding layer, effectively suppressing electromagnetic interference (EMI).

### Embodiment 2

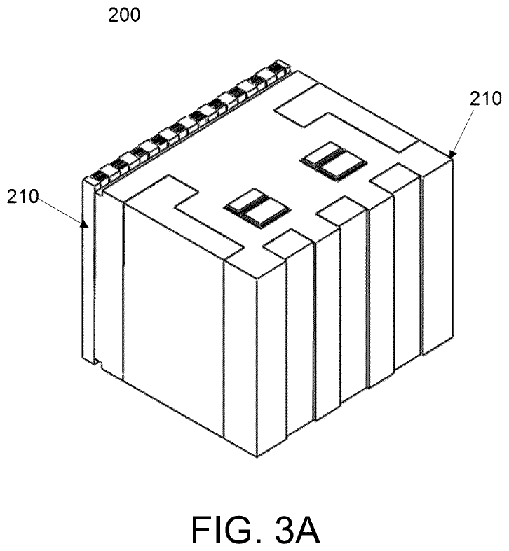

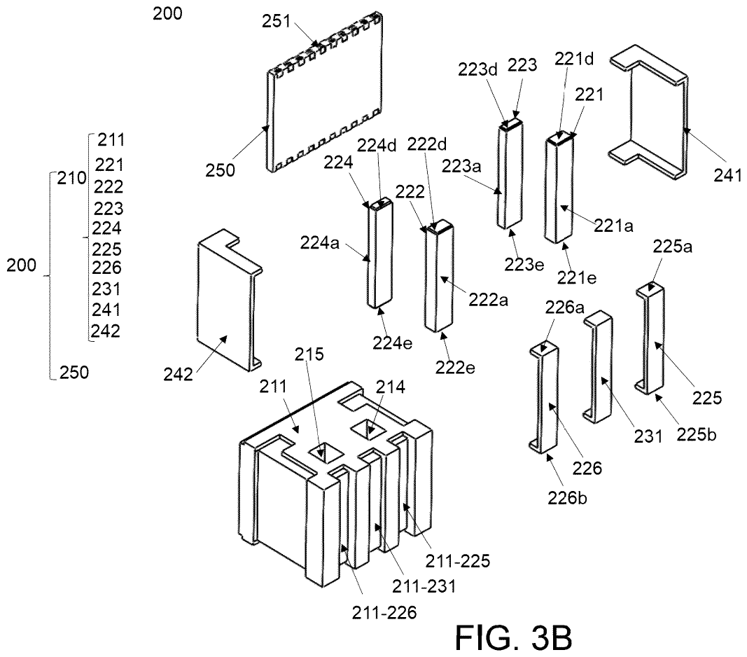

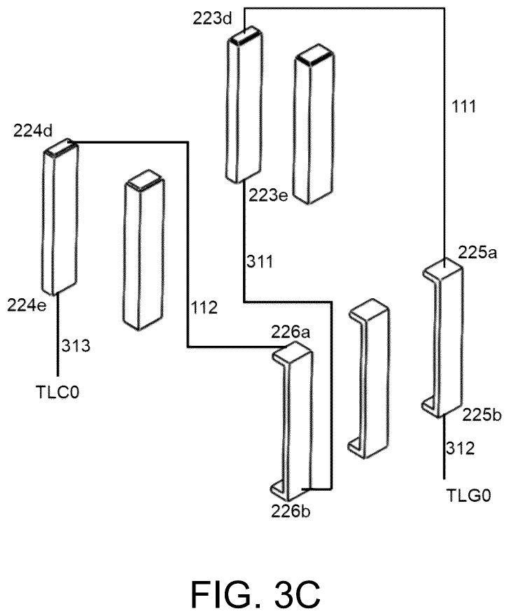

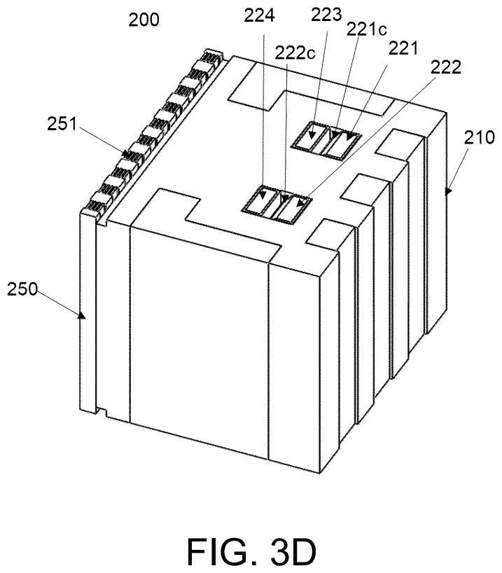

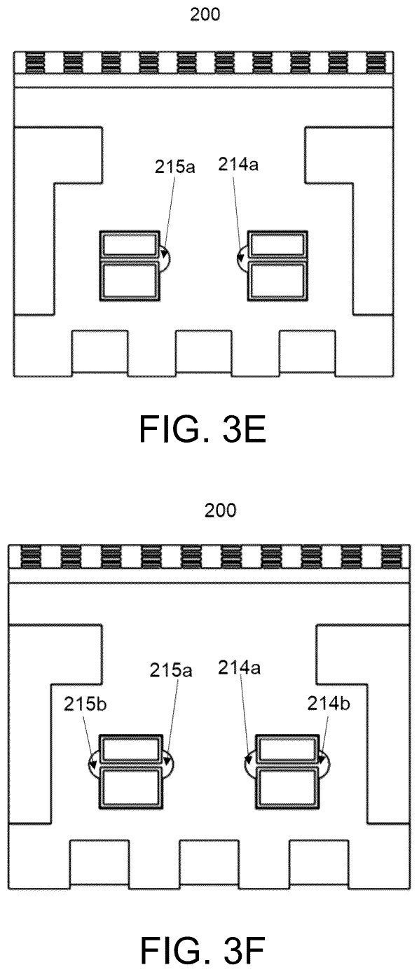

FIG. 3A is another embodiment of the intermediate assembly 200 of the present invention, and FIG. 3B is an exploded view of the structure of FIG. 3A. As shown in FIG. 3A and FIG. 3B, the difference between the embodiment and the embodiment shown in FIG. 2A is the winding limiting hole and winding of the magnetic core 211. The magnetic core 211 in the embodiment is provided with winding limiting holes 214 and 215, and the winding limiting holes 214/215 are square holes (ignoring chamfers). Both the main winding and the auxiliary winding are enameled insulating copper flat wires. Since the current flowing through the main winding is larger than the current flowing through the auxiliary winding, the width of the copper flat wire serving as the main winding is the same as the width of the copper flat wire serving as the auxiliary winding, but the thickness of the copper flat wire serving as the main winding is larger than that of the copper flat wire serving as the auxiliary winding. In this way, the direct-current impedance of the main winding can be reduced, so that the conversion efficiency of the VRM module is improved. In addition, one main winding and the corresponding auxiliary winding are closely arranged in the same winding limiting hole, so that the coupling coefficient approximate to 1 can be realized between the main winding and the auxiliary winding, the TLVR performance is effectively improved, the dynamic inductance is reduced, and the dynamic performance of the VRM module is improved. Electrical isolation between the main winding and the auxiliary winding is achieved by insulating paint films 221a, 222a, 223a and 224a to ensure safe and reliable operation of the VRM module.

The first auxiliary winding 221 is provided with a top pin 223d on the top surface 261, the bottom surface 262 is provided with a bottom pin 223e. The second auxiliary winding 224 is provided with a top pin 224d on the top surface 261, and the bottom surface 262 is provided with a bottom pin 224e. The first auxiliary electrical connector 225 is provided with a top pin 225a on the top surface 261, the bottom surface 262 is provided with a bottom pin 225b. The second auxiliary electrical connector 226 is provided with a top pin 226a on the top surface 261, and the bottom surface 262 is provided with a bottom pin 226b. The main winding and the power electrical connector are also respectively provided with pins on the top surface and the bottom surface, which will not be repeated here.

FIG. 3C is a schematic diagram of a connection mode of an auxiliary winding and an auxiliary electrical connector to realize a TLVR technology. As shown in FIG. 3C, TLG0 and TLC0 are two expansion pins arranged on a bottom substrate of the bottom assembly 300 for realizing a TLVR function. The TLG0 is electrically connected to a bottom pin 225b of the first auxiliary electrical connector 225 by means of a wiring 312 on the bottom substrate, and a top pin 225a of the first auxiliary electrical connector 225 is electrically connected to a top pin 223d of the first auxiliary winding 223 by means of a wire 111 on the top substrate 110 in the top assembly 100, a bottom pin 223e of the first auxiliary electrical connector 223 is electrically connected with a bottom pin 226b of the second auxiliary electrical connector 226 through a wire 311 on the bottom substrate, a top pin 226a of the second auxiliary electrical connector 226 is electrically connected with a top pin 224d of the second auxiliary winding 224 through a wire 112 on the top substrate 110, and a bottom pin 224e of the second auxiliary electrical connector 224 is electrically connected with a TLC0 pin on the bottom substrate through a wire 313 on the bottom substrate.

The structure and connection mode of the VRM module 10 with the TLVR technology are described above. In actual use, an N-phase TLVR power supply scheme (N is an even number) can be used for realizing an N-phase DC-DC converter with a TLVR technology by using N/2 VRM modules 10 (N is equal to 4 in the embodiment). Specifically, according to FIG. 1E, the TLC0 of the first VRM module is connected with the TLG0 of the second VRM module through the load mainboard, and the TLC0 of the second VRM module is connected with the TLG0 of the third VRM module through the load mainboard, and so on, the TLC0 of the last module and the TLG0 of the first module are connected on the load mainboard through the compensation inductor Le to form a closed auxiliary winding loop. Certainly, in some preferred embodiments, the compensation inductor Le can be not used, and the TLC0 of the last module is connected with the TLG0 of the first module through the load mainboard. Due to the fact that the TLVR technology is utilized, the N-phase inductors in the N-phase converter have anti-coupling characteristics with each other, lower dynamic inductance is achieved, higher steady-state inductance is obtained, and faster dynamic performance and higher conversion efficiency are obtained.

FIG. 3D is another preferred embodiment of the intermediate assembly 200 of the present invention. The embodiment has the same technical effect as the embodiment shown in FIG. 3A. The difference of the embodiment lies in that a chamfer 221c is disposed on the top surface 261 and is close to the side, adjacent to the first auxiliary winding 223 the first main winding 221; and a chamfer 222c is disposed on the top surface 261 and is close to the side, adjacent to the second auxiliary winding 224 the second main winding 222. Another chamfer(not shown in the figure) is disposed on the bottom surface and close to the side, adjacent to the auxiliary winding and the main winding. The chamfer is arranged, so that the risk that pins of the main winding and the auxiliary winding are welded with the top main board 110 and short-circuited when the pins and the bottom board are welded is reduced.

FIGS. 3E and 3F are another preferred embodiment of the intermediate assembly 200. As shown in FIG. 3E and FIG. 3F, one side of the winding limiting hole of the top surface 261 or the bottom surface 262 of the magnetic core 211 is provided with the glue dispensing hole positions 214 a and 215 a. As shown in FIG. 3F, the glue dispensing hole positions 214a/215a and 214b/215b at the two sides of the winding limiting hole can penetrate from the top surface of the magnetic core to the bottom surface of the magnetic core, or can only extend from the top surface and the bottom surface of the magnetic core to a certain depth from the interior of the magnetic core, and the depth is enough to accommodate the adhesive. The effect of arranging the glue dispensing hole position is to use a glue dispensing mode to connect the main winding, the auxiliary winding and the magnetic core are fixed together, so that the auxiliary winding and the magnetic core are mutually fixed, the assembly difficulty of the intermediate assembly is simplified, and the assembly yield of the VRM module is enhanced.

### Embodiment 3

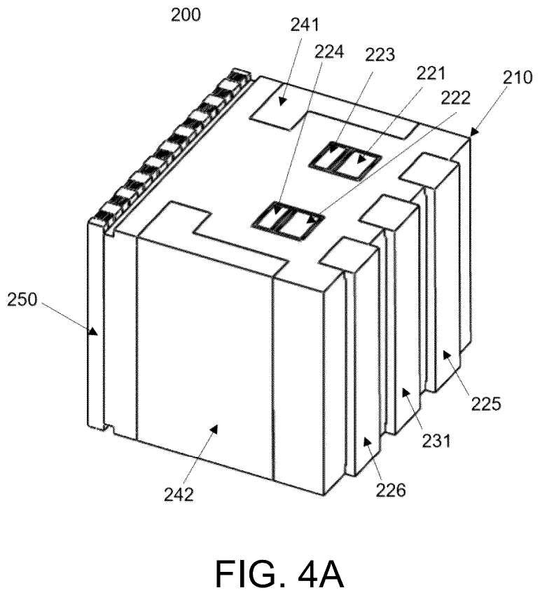

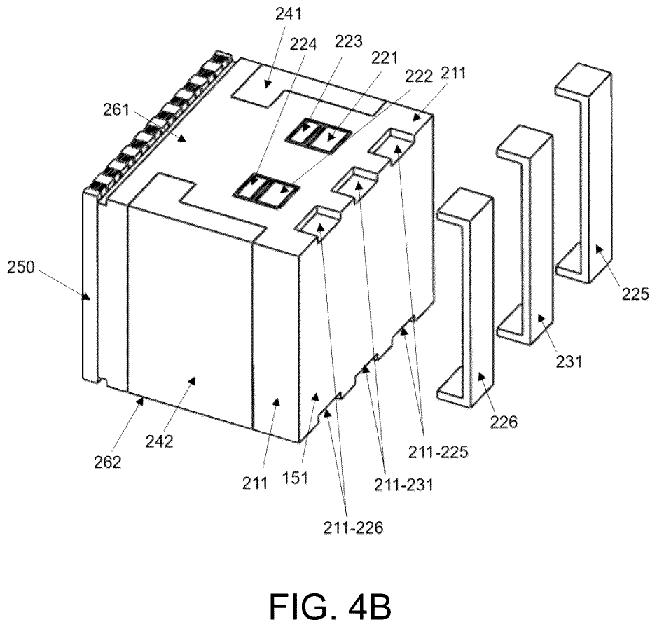

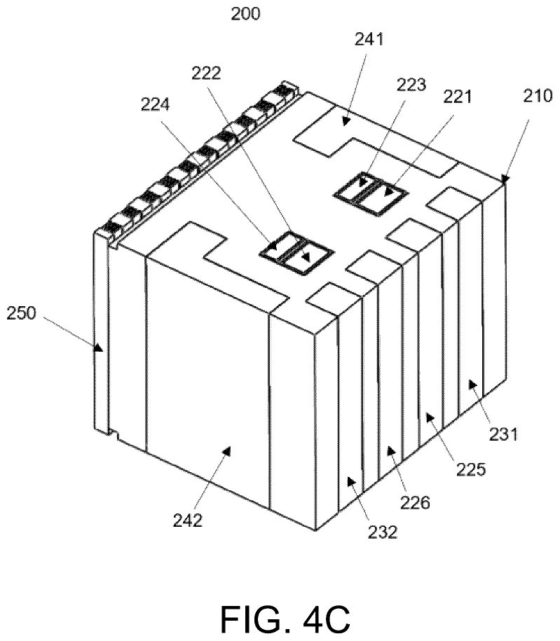

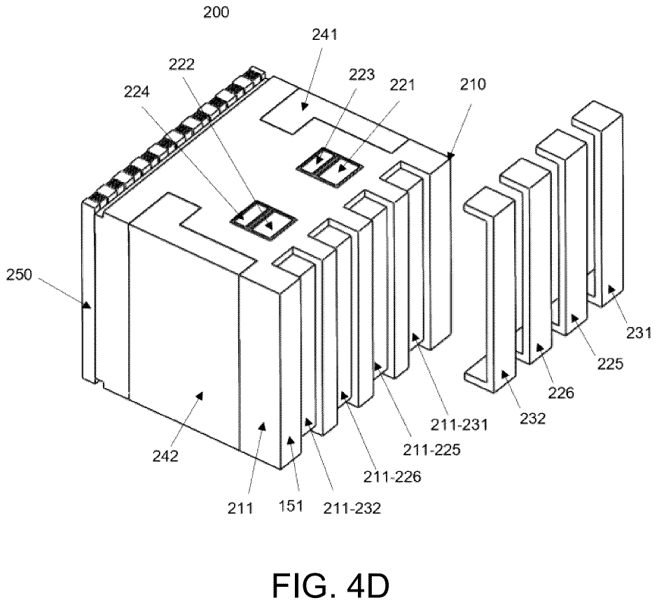

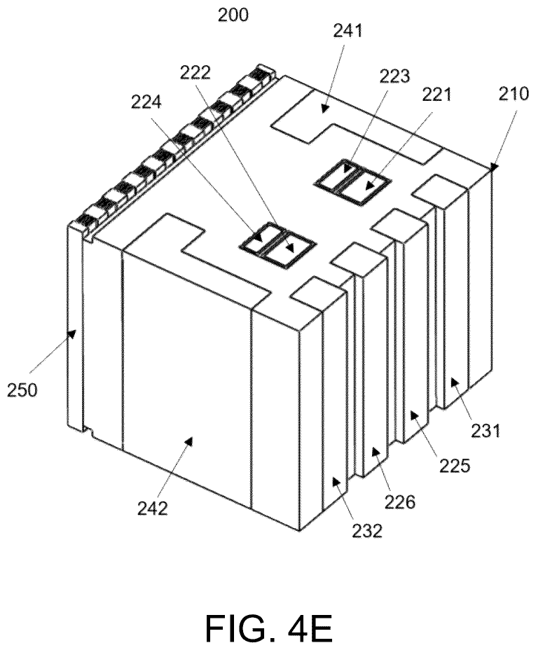

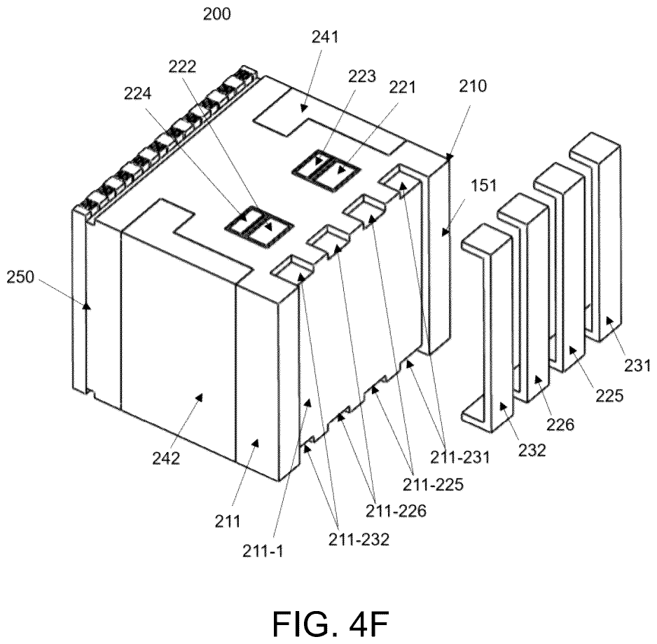

FIG. 4A is a schematic structural diagram of another embodiment of the intermediate assembly 200, and FIG. 4B is an exploded view of the structure of FIG. 4A. As shown in FIG. 4A and FIG. 4B, the technical effect of the embodiment is the same as that of the embodiment shown in FIG. 3A. The difference in the embodiment lies in that the limiting grooves 211/231, 211-225 and 211-226 of the first power electrical connector 231, the first auxiliary electrical connector 225 and the second auxiliary electrical connector 226 are only arranged on the top surface 261 and the bottom surface 262 of the magnetic core, and the first side surface 151 of the magnetic core is a plane. The arrangement has the advantages that the parasitic inductance of the first auxiliary electrical connector 225 and the second auxiliary electrical connector 226 is small, the parasitic inductance of the whole TLVR loop is reduced, the dynamic inductance of the TLVR is further reduced, and the dynamic performance of the VRM module is further improved.

FIG. 4C is a schematic structural diagram of another embodiment of the intermediate assembly 200, and FIG. 4D is an exploded view of the structure of FIG. 4C. As shown in FIG. 4C and FIG. 4D, the technical effect of the embodiment is the same as that of the embodiment in FIG. 3A. The difference lies in that the first auxiliary electrical connector 225 and the second auxiliary electrical connector 226 are arranged in the middle of the first side surface 151 of the magnetic core, and the two auxiliary electrical connectors are arranged adjacent to each other. In the present embodiment, in addition to the first power electrical connector 231, a first power electrical connector 232 is additionally provided, wherein the first power electrical connector 231 and the first power electrical connector 232 are both disposed on a first side surface 151 of the magnetic core, and are respectively disposed on two sides of the first auxiliary electrical connector 225 and the second auxiliary electrical connector 226. In the embodiment, the first auxiliary electrical connector 225 and the second auxiliary electrical connector 226 are adjacently arranged, so that the two auxiliary electrical connectors are mutually coupled, a part of parasitic inductance is counteracted, the parasitic inductance of the whole TLVR loop is further reduced, the dynamic inductance of the TLVR is further reduced, and the dynamic performance of the VRM module is further improved.

FIG. 4E is a schematic structural diagram of another embodiment of the intermediate assembly 200 of the present invention, and FIG. 4F is an exploded view of the structure of FIG. 4E. As shown in FIG. 4E and FIG. 4F, the technical effect of the embodiment is the same as that of the embodiment in FIG. 3C. The difference in the embodiment lies in that the limiting grooves of the first auxiliary electrical connector 225, the second auxiliary electrical connector 226 and the first power electrical connector 231/232 are connected together to form a side wall groove 211-1 of the first side surface 151. That is, the first auxiliary electrical connector 225 and the second auxiliary electrical connector 226 are arranged adjacent to the first side surface of the magnetic core, and no magnetic core material exists between the two auxiliary electrical connectors. The arrangement has the advantages that a part of parasitic inductance is counteracted through mutual coupling between the first auxiliary electrical connector 225 and the second auxiliary electrical connector 226, so that the parasitic inductance of the whole TLVR loop is further reduced, the dynamic inductance of the TLVR is further reduced, and the dynamic performance of the VRM module is further improved. Meanwhile, the high-frequency parasitic inductance of the power loop formed between the first power electrical connector 231/232 and the second power electrical connector 241/242 is maintained, so that the resonance point of the resonance oscillation between the high-frequency parasitic inductance of the input power loop and the input capacitor is far away from the equivalent working frequency of the VRM, so that efficient and reliable work of the VRM module is ensured.

### Embodiment 4

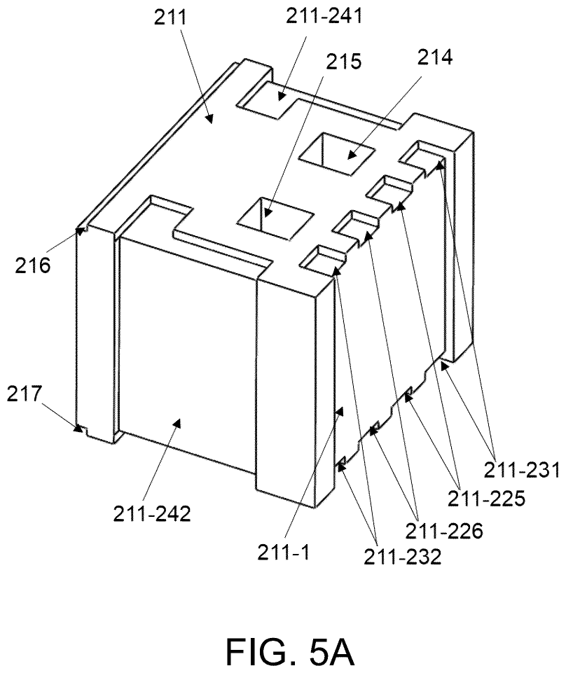

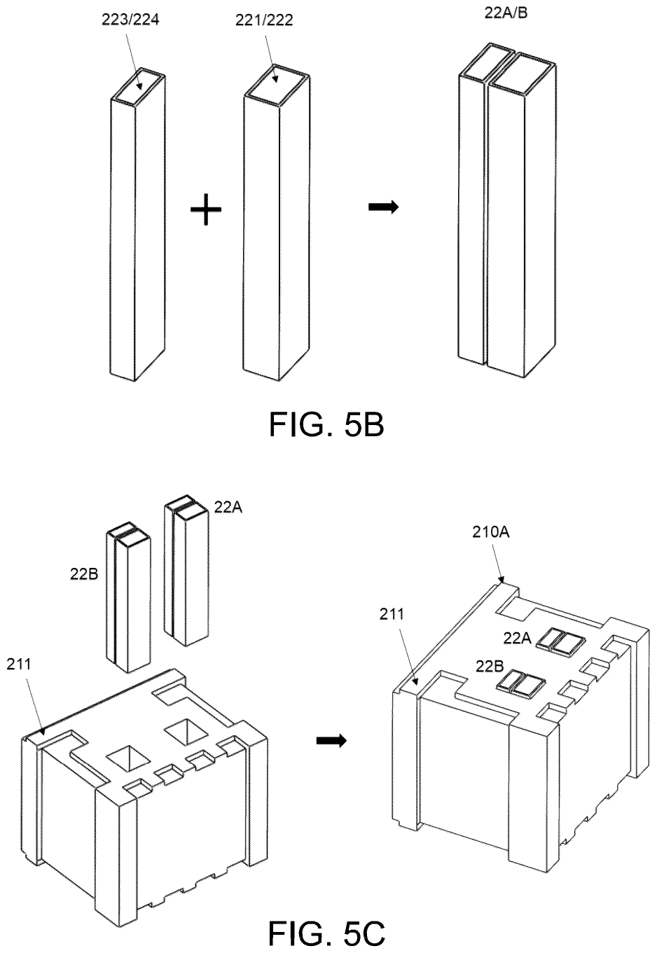

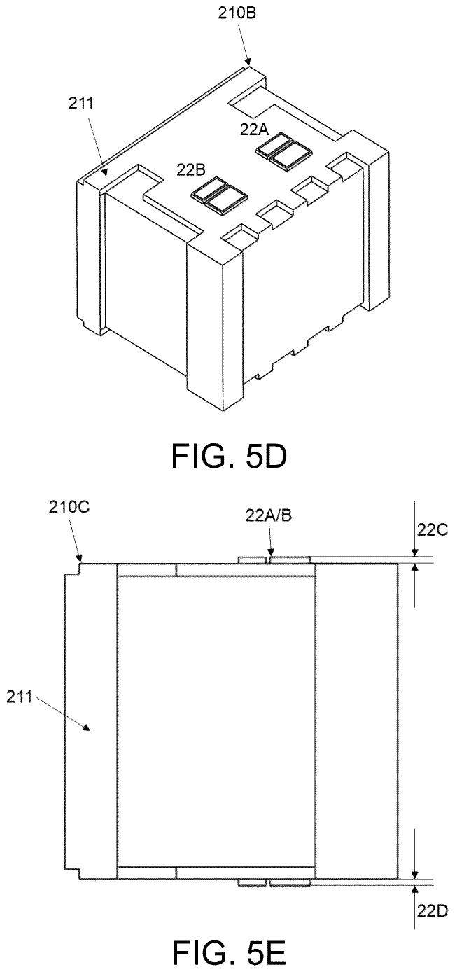

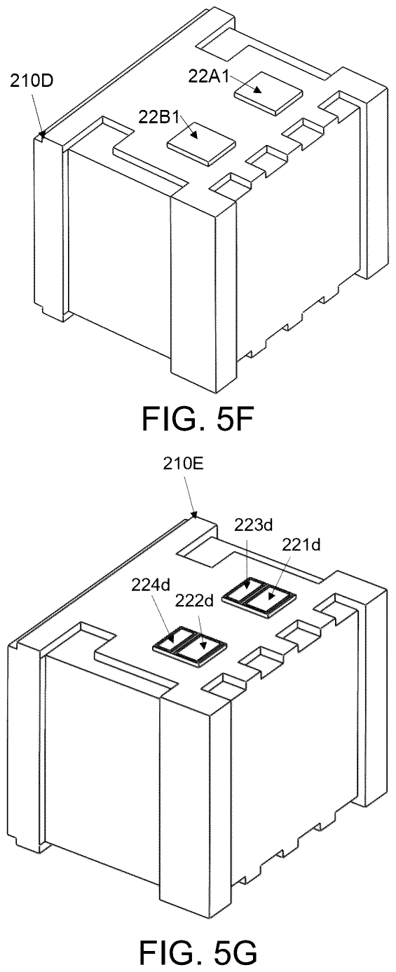

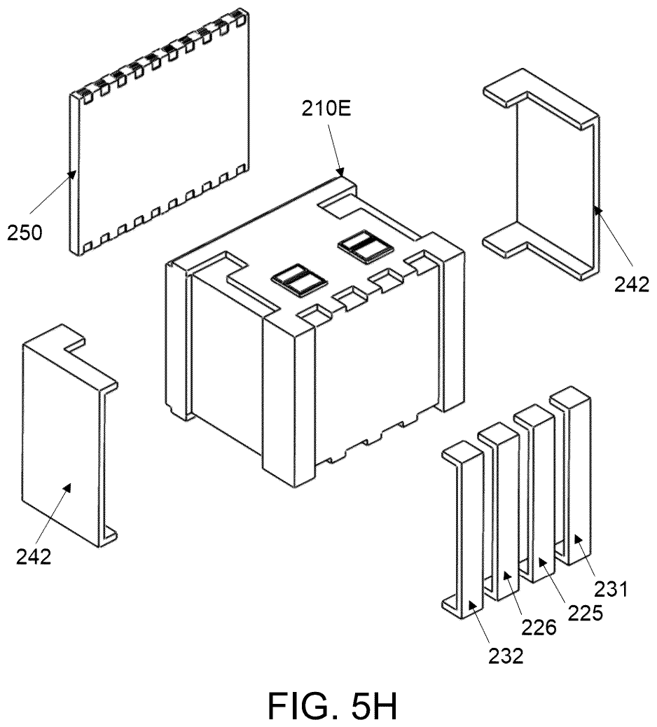

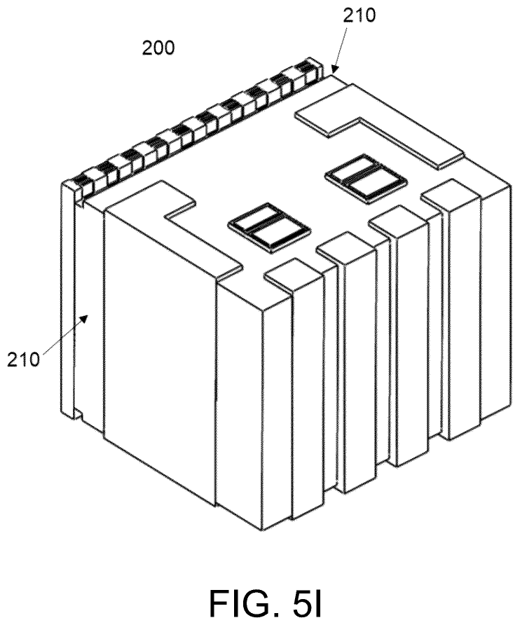

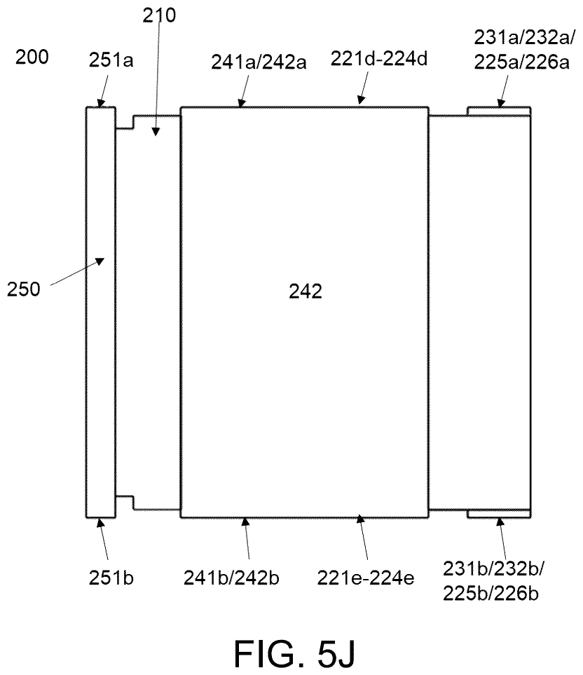

FIG. 5A to FIG. 5J show an intermediate assembly 200 (equivalent to an inductor integrated assembly, and the intermediate assembly in other embodiments of the present invention is equivalent to an inductor integrated assembly. The invention discloses a manufacturing process and a manufacturing method.

Step 1, as shown in FIG. 5A, a magnetic powder core material, such as FeSi, FeSiAl, FeNi, FeSiNi, FeSiCr, Fe (iron powder) or mixed powder of various magnetic powder core materials, is put into a mold to be pressed into the shape of the magnetic core 211 shown in FIG. 5A. The pressed and formed magnetic core 211 comprises a winding positioning hole 214/215, an avoidance groove 216/217, a sidewall groove 211-1, a first power electrical connector limiting groove 211-231, a second power electrical connector limiting groove 211-232, a first auxiliary electrical connector limiting groove 211-225, a second auxiliary electrical connector limiting groove 211-226 and a second power electrical connector limiting groove 211-241 and 211-242. After the magnetic core is pressed and formed, so that the magnetic powder core material obtains ideal magnetic performance.

Step 2, as shown in FIG. 5B, the enameled copper flat wire is cut or stamped into the required size and shape, and the main winding and the auxiliary winding are manufactured. A main winding and an auxiliary winding are then glued together to form winding units 22A and 22B.

Step 3: as shown in FIG. 5C, the winding units 22A and 22B are combined with the annealed magnetic cores 211 to form an integrated inductor semi-finished product 210A, and it is ensured that the winding units 22A and 22B protrude from the top surface 261 and the bottom surface 262 of the magnetic core by a certain height. Preferably, the height of each winding unit protruding from the top surface and/or the bottom surface is the same.

Step 4, as shown in FIG. 5D, the integrated inductor semi-finished product 210A obtained in the third step is subjected to impregnation treatment, that is, the inductor semi-finished product 210A is put into the impregnation liquid of the epoxy resin type, so that the impregnation liquid is fully permeated into the magnetic powder core material, and the effects of enhancing the strength of the magnetic core and fixing the winding unit are achieved. After the impregnation treatment, the inductor semi-finished product 210B is obtained.

Step 5, as shown in FIG. 5E, the inductor semi-finished product 210B obtained in the fourth step is ground, the main grinding winding unit 22A/B protrudes out of the top surface and the bottom surface of the magnetic core, and it is ensured that the height 22C and 22D of the winding unit 22A/B protruding out of the magnetic core on the top surface and the bottom surface are approximately equal (the height error ranges from 0 μm to 200 μm). In a preferred embodiment, the winding unit protrudes from 0 μm to 100 μm out of the surface of the magnetic core. A relatively small height error can obtain better pad flatness in the assembly process. The inductor semi-finished product 210C is obtained by grinding.

Step 6: as shown in FIG. 5F, a coating process (a surface coating process) is performed on the ground inductor semi-finished product 210C, that is, a layer of chemical substance is covered on the surface of the inductor, so that the magnetic core plays a role in moisture prevention, rust prevention, dust prevention and corrosion resistance; and meanwhile, the protruding end of the winding unit is also covered by the Coating glue. The inductor semi-finished product 210D is obtained after coating is completed.

Step 7, as shown in FIG. 5G, removing the Coating glue on the surface of the end part of the winding unit of the inductor semi-finished product 210D in a laser mode, exposing the copper base material of the winding unit, and putting the integrated inductor semi-finished product into the electroplating solution for electroplating. The detailed electroplating process comprises the following steps: firstly, electroplating a layer of copper, then electroplating a layer of nickel, and then electroplating a layer of tin. The purpose of electroplating is to ensure that the pins of the winding are not oxidized and are easy to weld. The inductor semi-finished product 210E is obtained by electroplating.

Step 8: as shown in FIG. 5H, FIG. 4I and FIG. 4J, on the basis of the inductor semi-finished product 210E obtained in the seventh step, the sequential order of assembling the power electrical connectors 231/232/241/242, the auxiliary electrical connectors 225/226 and the signal vertical plate 250 is not limited, and the intermediate assembly 200 shown in FIG. 5I is obtained after assembly is completed. FIG. 5J is a side view of FIG. 5I, the assembly process requires the top surfaces of the pins 251a, 241a/242a, 221d-224d, 231a/232a and 225a/226a for welding on a plane, that is, the flatness tolerance is less than 150 μm. Pins 251b, 241b/242b, 221e-224e, 231b/232b and 225b/226b for welding are on a plane, ie, the flatness tolerance is less than 150 μm. In certain preferred embodiments, the flatness tolerance is less than 100 μm. Meanwhile, the height of all the pins protruding out of the surface of the magnetic core ranges from 0 μm to 200 μm, and in certain preferred embodiments, the height of all the pins protruding out of the surface of the magnetic core ranges from 0 μm to 100 μm.

In certain preferred embodiments, the sequence of the fifth step and the sixth step can be exchanged, and the step of removing the Coating glue by the laser in the seventh step is omitted, so that the process is optimized, and the cost caused by the process is reduced.

### Embodiment 5

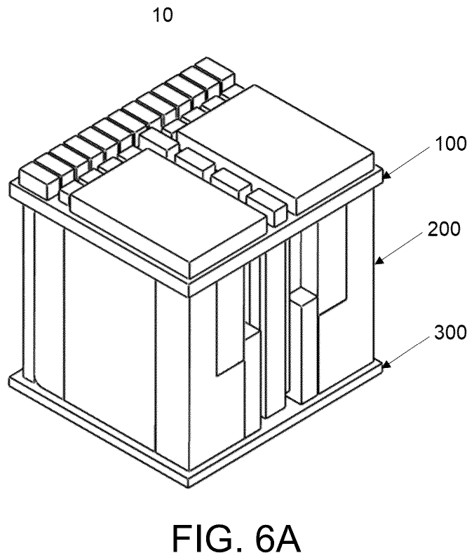

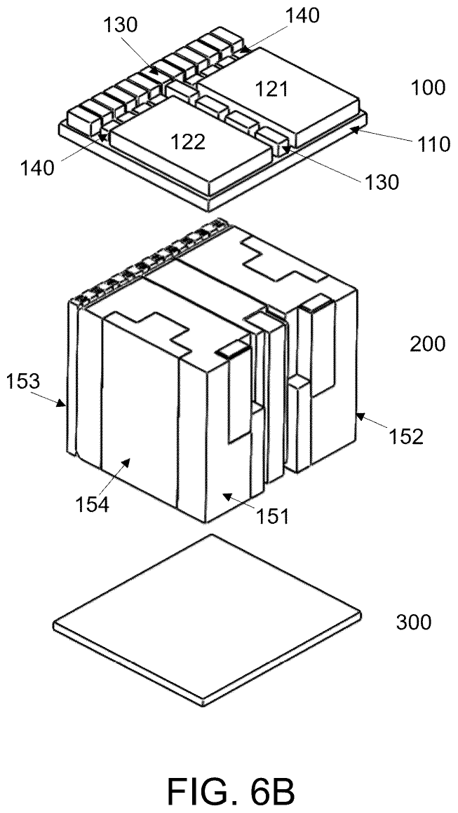

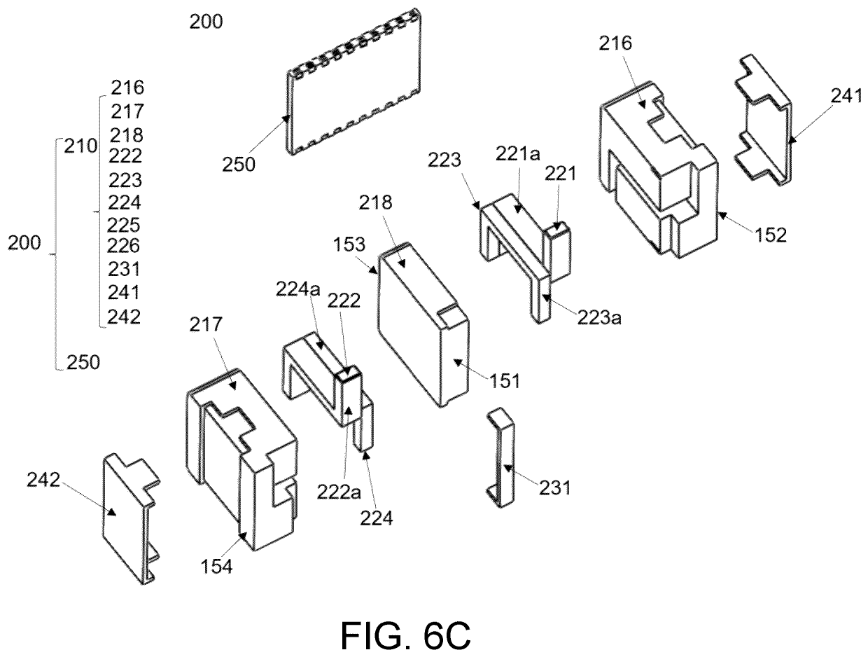

FIG. 6A is a schematic structural diagram of another embodiment of the circuit topology in FIG. 1E, and FIG. 6B is an exploded view of the structure of FIG. 6A. As shown in FIGS. 6A and 6B, the VRM module 10 comprises a top assembly 100, the intermediate assembly 200 and the bottom assembly 300. The top assembly 100 comprises a top substrate 110, a first switch unit 121, a second switch unit 122, an input capacitor 130 and other passive elements 140.

The first switch unit 121 and the second switch unit 122 are disposed on the top substrate 110 and are disposed adjacent to the first side surface 151. The SW pin of the switch unit is disposed adjacent to the first side surface 151 of the top substrate 110. A signal pin of the switch unit is disposed adjacent to the third side 153. The input capacitor 130 is disposed between the two switch units or adjacent to the third side surface 153. Other passive elements 140 are disposed between the switch unit and the input capacitor 130. In this way, the path of the power loop can be the shortest, so that the conversion efficiency of the module is improved; and meanwhile, the shortest path of the signal loop can be obtained, so that the anti-interference capability of the signal loop is improved.

FIG. 6C is an exploded view of the intermediate assembly 200 in FIG. 6B. As shown in FIG. 6C, the intermediate assembly 200 includes an inductor 210 and a vertical plate 250, the inductor 210 includes a first magnetic core 216, a second magnetic core 217, a third magnetic core 218, a first main winding 221, a second main winding 222, a first auxiliary winding 223, a second auxiliary winding 224, a first power electrical connector 231, and a second power electrical connector 241/242. The first power electrical connector 231 is arranged adjacent to the first side surface 151 of the magnetic core; the second power electrical connectors 241/242 are disposed adjacent to the second side surface 152 and the fourth side surface 154 of the magnetic core, respectively, adjacent to the third side surface 153 of the magnetic core.

The first magnetic core 216 and the second magnetic core 217 are respectively used for limiting the first main winding 221, the first auxiliary winding 223, the second main winding 222 and the second auxiliary winding 224. The first magnetic core 216 is provided with a limiting groove for assembling the second power electrical connector 241; the second magnetic core 217 is provided with a limiting groove for assembling the second power electrical connector 242; and a limiting step is arranged on the third magnetic core 218 and used for assembling the first power electrical connector 231. The first main winding and the second main winding are both of a “Z” shaped structure formed by bending or stamping the enameled insulating copper flat wire; and the auxiliary winding is of an “n” shaped structure formed by bending or stamping the enameled insulating copper flat wire.

A portion (i.e., a first end) extending toward the top surface of the main winding is adjacent to the first side surface 151 of the magnetic core and exposed in air; the main winding both extend from the middle portion of the magnetic core to the bottom surface (ie, a second end) is adjacent to the third side surface 153. The two ends of the auxiliary winding extend towards the bottom surface, one end of the auxiliary winding is adjacent to the first side surface 151 of the magnetic core and is exposed in air; the other end of the auxiliary winding extending towards the bottom surface from the portion of the middle of the magnetic core is arranged close to the third side surface 153. On one hand, the overlapped parts of the main winding and the auxiliary winding in the horizontal direction are completely surrounded by the magnetic core, and the magnetic flux generated by the current flowing through the horizontal part passes through the magnetic core material on the length of the whole magnetic circuit, so that the mutual inductance of the main winding and the auxiliary winding is large. On the other hand, the part of the main winding and the auxiliary winding close to the first side surface of the magnetic core and exposed in the air is not overlapped in the horizontal direction, and the magnetic flux generated by the current flowing through the part of winding can pass through the air because the magnetic resistance of the air is large, so that the leakage inductance generated by the winding is small. Therefore, the coupling coefficient between the main winding and the auxiliary winding is high, the dynamic inductance of the TLVR is reduced, and the dynamic performance of the VRM module is improved.

The magnetic core, the winding, the power electrical connector and the vertical plate in the embodiment are manufactured into a TLVR inductor in an assembling mode, and the manufacturing process is simple. The magnetic core material can be a powder core or a ferrite material core.

According to the structure of any two-phase coupling inductor formed by the inventive concept, the two auxiliary windings can be connected through the electrical connector when the two-phase VRM module is formed, and two auxiliary winding Expansion pins TLG0 and TLC0 are formed and used for being used in series with other two-phase VRM modules, so that any even number N-phase DC-DC converter with the TLVR function is achieved, and faster dynamic performance and higher efficiency are achieved; the shape and the position of the electrical connector are not limited to the form in the embodiment.

By utilizing the method in the embodiment, reference can be made to the description in the embodiment, the coupling between the main winding and the auxiliary winding can be strong coupling or weak coupling; and the external compensation inductor Le can be selected or the external compensation inductor Le can be neglected to be directly connected.

### Embodiment 6

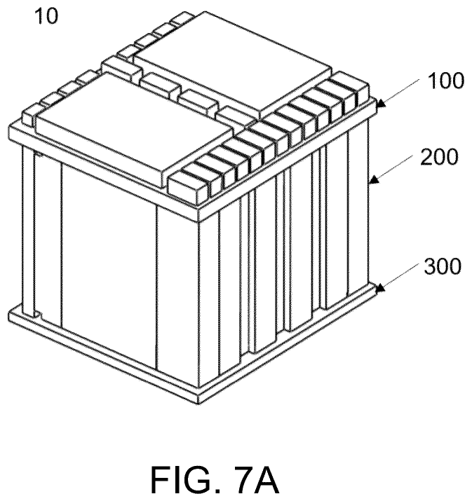

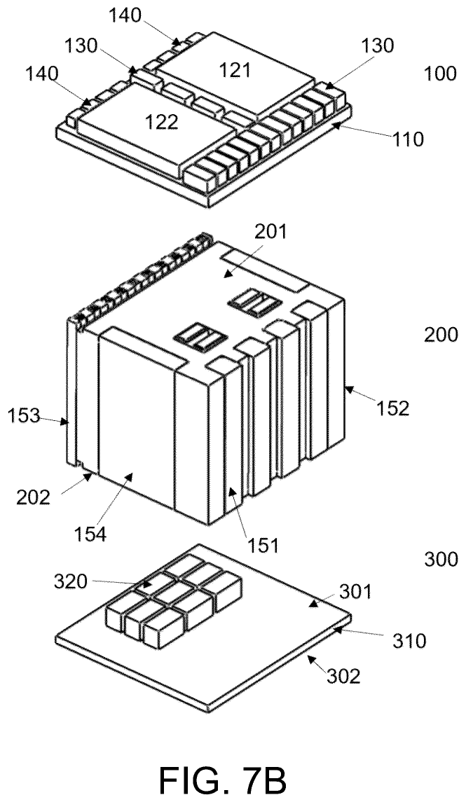

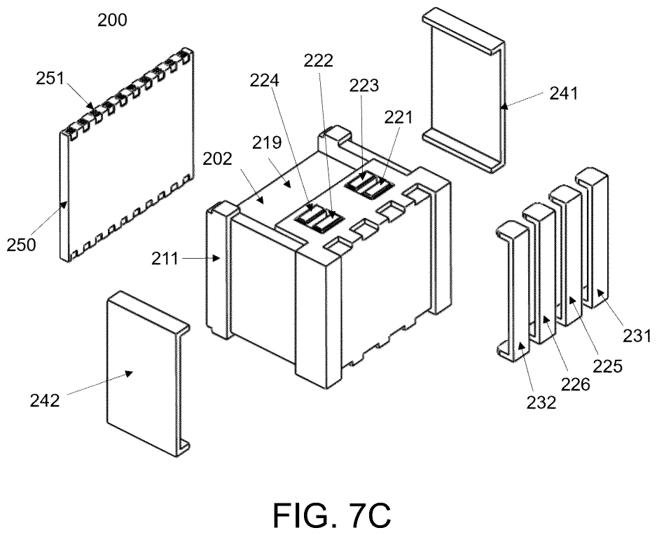

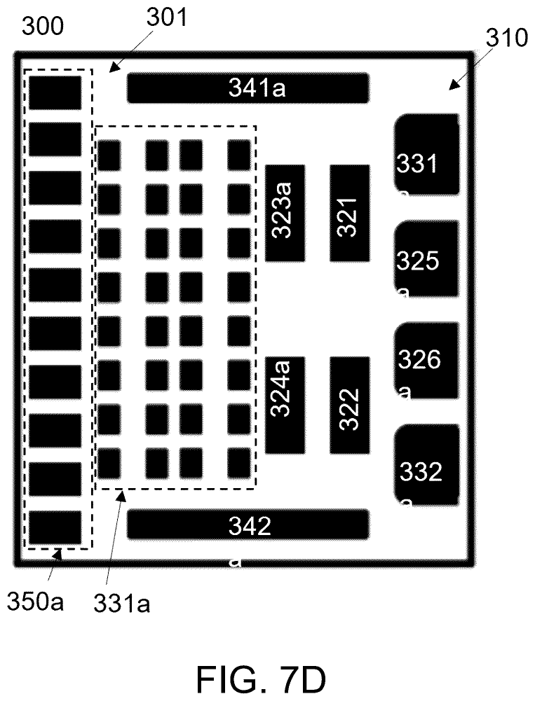

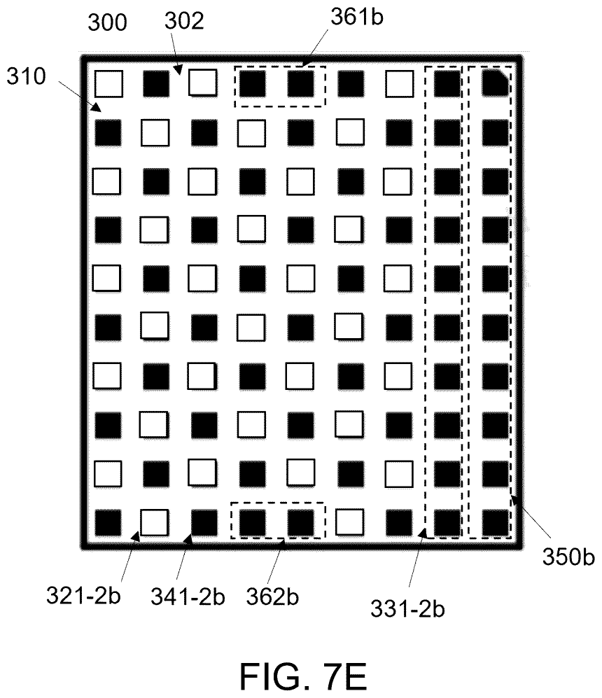

FIG. 7A is a schematic structural diagram of another embodiment of the circuit topology in FIG. 1E, and FIG. 7B is an exploded view of the structure of FIG. 7A. As shown in FIG. 7A and FIG. 7B, the VRM module 10 comprises a top assembly 100, a intermediate assembly 200 and a bottom assembly 300. The top assembly 100 comprises a top substrate 110, a first switch unit 121, a second switch unit 122, an input capacitor 130 and other passive elements 140. The top assembly 100 in the embodiment is the same as the top assembly 100 in the first embodiment. The difference between the embodiment and the first embodiment lies in the structural layout of the intermediate assembly 200 and the bottom assembly 300.

Specifically, as shown in the exploded view of the middle assembly 200 shown in FIG. 7C, the groove 219 is provided on the bottom surface 202 of the intermediate assembly 200. The groove 219 is provided between the third side surface 153 and the auxiliary winding 223/224, and is adjacent to the second side surface 152, the third side surface 153, and the fourth side surface 154. As shown in FIG. 7B, and the bottom assembly 300 comprises a bottom substrate 310 and an output capacitor 320. The output capacitor 320 is arranged on the top surface 301 of the bottom substrate 310. After the bottom assembly 300 and the intermediate assembly 200 are assembled together, the groove 219 is used for accommodating the output capacitor 320. In the embodiment, the output capacitor 320 is arranged close to the output positive end Vo+and the grounding end of the VRM module 10, and the dynamic performance of the VRM module is further improved.

FIG. 7D and FIG. 7E are pin profiles of a top surface 301 and a bottom surface 302 of a bottom substrate 310. The input positive pins 331a and 332a are arranged on the top surface 301 of the bottom substrate 310 and are respectively welded and electrically connected with the bottom pins of the first power electrical connector 231 and 232. The input positive pins 331a and 332a are electrically connected by wiring provided on the bottom substrate 310. The grounding pins 341a and 342a are arranged on the top surface 301 of the bottom substrate 310 and are respectively welded and electrically connected with the bottom pins of the second power electrical connector 241 and 242. The ground pins 341 a and 342 a are electrically connected by wiring disposed on the bottom substrate 310. The signal pin 350a is arranged on the top surface 301 of the bottom substrate 310 and is welded and electrically connected with the bottom pin of the signal electric connector 251. The output positive pins 321a and 322a are arranged on the top surface 301 of the bottom substrate 310 and are respectively welded and electrically connected with the bottom pins of the first main winding 221 and the second main winding 222; and the output positive pins 321a and 322a are electrically connected with the output positive terminal Vo+of the VRM module 10. The auxiliary winding pins 323a and 324a are arranged on the top surface 301 of the bottom substrate 310 and are respectively welded and electrically connected with the bottom pins of the first auxiliary windings 223 and 224. The auxiliary pins 325a and 326a are disposed on the top surface 301 of the bottom substrate 310 and are respectively welded and electrically connected to the bottom pins of the auxiliary electrical connectors 225 and 226. The positions of all the pins arranged on the top surface of the bottom substrate are in one-to-one correspondence with the positions of the bottom pins of the intermediate assembly, and details are not described herein again.

A signal pin 350b, an input positive pin 331-2b, a function extension pin 361-2b, an output positive pin 321-2b and a grounding pin 341-2b are arranged on the bottom surface of the bottom substrate. The output positive pin 321-2b is the black box in FIG. 7E, and the grounding pin 341-2b is a white box outside the dotted line frame; the output positive pin and the grounding pin are arranged in a staggered manner (i.e., the upper, lower, left and right sides of any output positive pin 321-2b are all configured to be grounding pins 341-2b, and the upper, lower, left and right sides of any one grounding pin 341-2b are all configured to output positive pins 321-2b), so that the layout can reduce the parasitic inductance between the output positive wiring and the grounding wiring. Preferably, the VRM module structure disclosed by the embodiment is suitable for application of vertical power supply. The bottom surface 302 of the bottom substrate 310 is directly connected with the load, so that the requirement of the load end on the capacity of the output capacitor is further reduced under the condition that the dynamic performance of the VRM module is met, and the number of output capacitors and the occupied volume are reduced. Certainly, the shape of the pin arranged on the bottom surface 302 is not limited to a square shape or a circle. The circular pin can improve the utilization rate of copper, reduce the direct current impedance of the current flowing through the path, and improve the conversion efficiency of the VRM module; and meanwhile, the inductance of the parasitic inductor is further reduced, and the dynamic performance of the module is improved.

### Embodiment 7

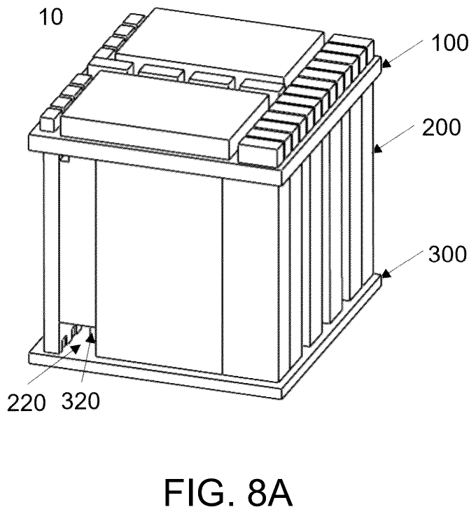

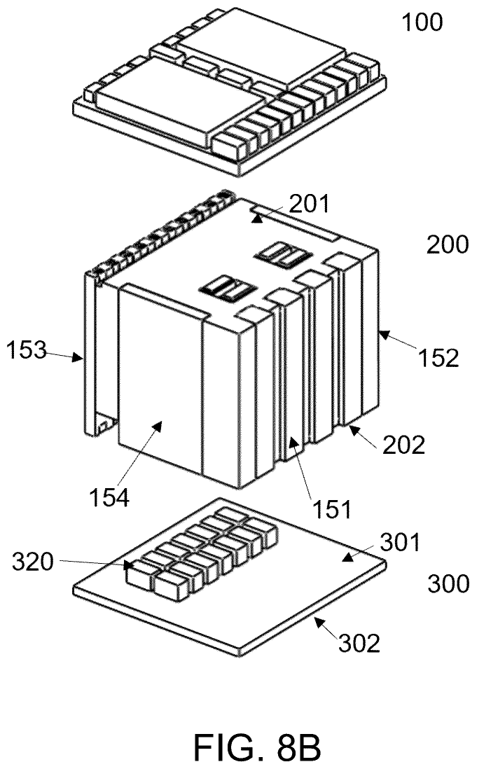

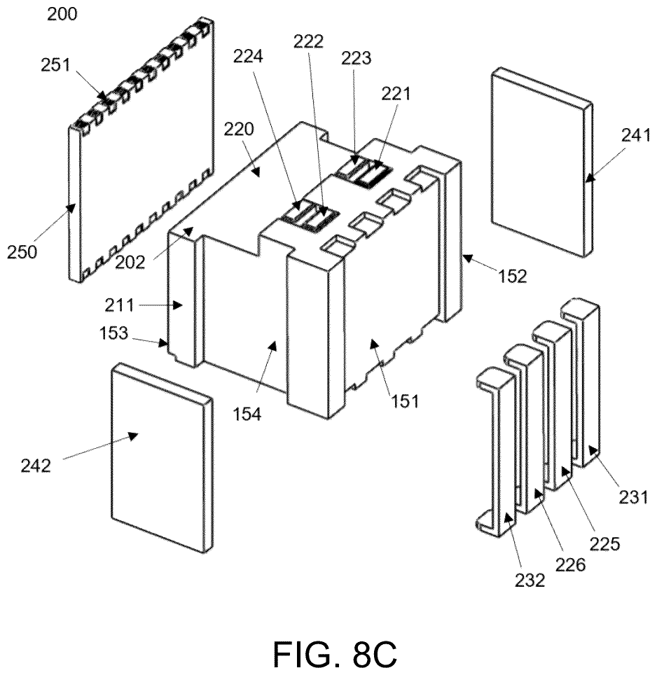

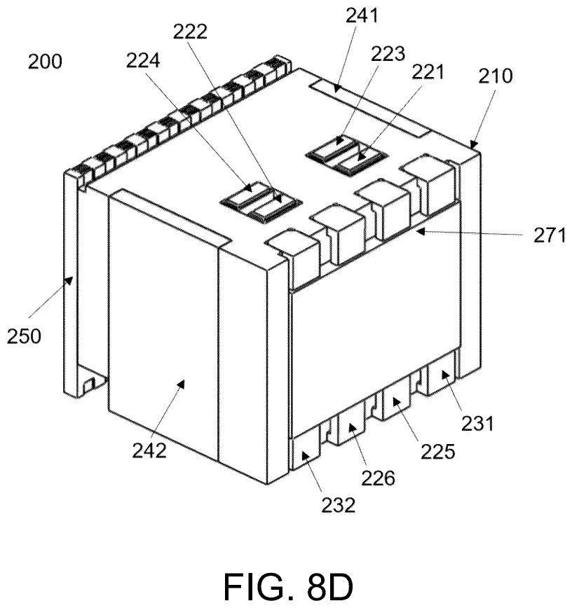

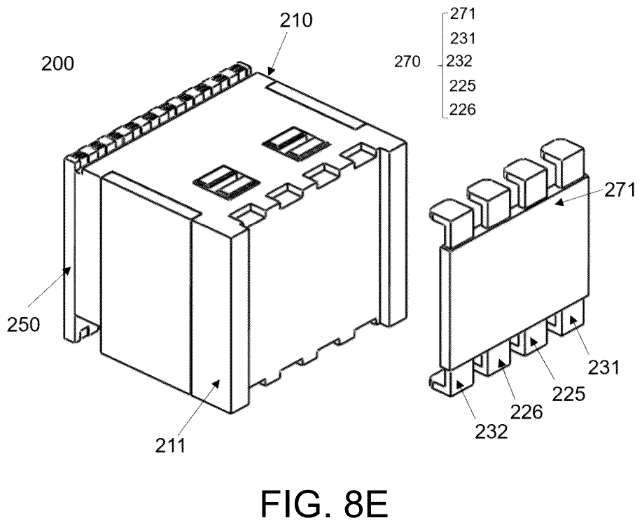

FIG. 8A is a schematic structural diagram of another embodiment of the circuit topology in FIG. 1E, FIG. 8B is an exploded view of the structure of FIG. 8A, and FIG. 8C illustrates an exploded view of the intermediate assembly 200. As shown in FIG. 8A to FIG. 8C, the difference from Embodiment 6 is the structure of the intermediate assembly 200. The step 220 is disposed on a bottom surface 202 of the intermediate assembly 200, and is also configured to accommodate the output capacitor 320 on the bottom substrate. The step 220 is disposed between the third side surface 153 and the auxiliary windings 223 and 224, extends to the second side surface 152, the third side surface 153, and the fourth side surface 154, and passes through the second side surface 152 and the fourth side surface 154. In the embodiment, the shapes of the second power electrical connector 241 and 242 are set to be rectangular copper sheets, and the rectangular copper sheets are assembled with the magnetic core 211 in an assembling mode, so that the advantage of doing so is that the structure of the step 220 in the embodiment can be better matched. In another embodiment, the second power electrical connector 241 and the second power electrical connector 242 can also be integrally pressed with the magnetic core 211. In the embodiment, the structure of the step 220 can increase the accommodating space of the output capacitor 320, that is, more capacitors can be arranged on the bottom substrate 210, and the capacity of the output capacitor is further increased, so that the VRM module obtains better dynamic performance.

FIG. 8D is another embodiment of the intermediate assembly 200, for example, FIG. 8E is an exploded view of the intermediate assembly shown in FIG. 8D. As shown in FIG. 8D and FIG. 8E, the first power electrical connectors 231 and 232 and the auxiliary winding electrical connectors 225 and 226 are integrated together by means of the insulating housing 271 to form the connector assembly 270. In the production process, the connector assembly 270 can be integrally assembled to the magnetic core 211, thereby simplifying the production process flow of the module, improving the assembly efficiency of the module, and reducing the production cost of the module.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present invention. Various modifications to these embodiments will be readily apparent to those skilled in the art, and the generic principles defined herein may be implemented in other embodiments without departing from the spirit or scope of the invention. Thus, the present invention will not be limited to the embodiments shown herein but is to be accorded the widest scope consistent with the principles and novel features disclosed herein.

Although the embodiments of the invention have been shown and described above, it can be understood that the above-mentioned embodiments are exemplary and should not be construed as limiting the invention. A person having ordinary skill in the art may make changes, corrections, substitutions, and modifications to the abovementioned embodiments within the scope of the invention.

What is claimed is:

1. A two-phase voltage regulator module, comprising a top assembly, an intermediate assembly and a bottom assembly;
wherein the top assembly comprises a top substrate;
the intermediate assembly comprises a magnetic core, a first main winding, a second main winding, a first auxiliary winding, a second auxiliary winding, a first auxiliary electrical connector and a second auxiliary electrical connector; wherein the intermediate assembly further comprises a top surface and a bottom surface which are opposite to each other, a first side surface and a third side surface which are opposite to each other, and a second side surface and a fourth side surface which are opposite to each other, wherein each of the first side surface, the second side surface, the third side surface and the fourth side surface is arranged between the top surface and the bottom surface;
the first main winding and the first auxiliary winding are adjacently arranged, and the first main winding and the first auxiliary winding are electrically isolated; the second main winding and the second auxiliary winding are adjacently arranged, and the second main winding and the second auxiliary winding are electrically isolated; the first main winding, the second main winding, the first auxiliary winding and the second auxiliary winding both comprise a top surface bonding pad arranged on the top surface and a bottom surface bonding pad arranged on the bottom surface; and the first auxiliary electrical connector and the second auxiliary electrical connector both comprise top pins arranged on the top surface and bottom pins arranged on the bottom surface;
the bottom assembly comprises a first expansion pin and a second expansion pin;
the first auxiliary winding and the first auxiliary electrical connector are electrically connected through the top surface bonding pad, the top pins and a top substrate; the second auxiliary winding and the second auxiliary electrical connector are electrically connected through the top surface bonding pad, the top pins and the top substrate; the first auxiliary winding and the second auxiliary electrical connector are electrically connected through the bottom surface bonding pad, the bottom pins and the bottom assembly; the bottom pins of the first auxiliary electrical connector is electrically connected with the first expansion pin; and the bottom surface bonding pad of the second auxiliary winding is electrically connected with the second expansion pin.

2. The two-phase voltage regulator module of claim 1, wherein structures of the first main winding, the second main winding, the first auxiliary winding and the second auxiliary winding are the same; and cross sections areas of the first auxiliary winding and the second auxiliary winding are smaller than sectional areas of the first main winding and the second main winding.

3. The two-phase voltage regulator module of claim 1, wherein the magnetic core comprises two main winding limiting holes and two auxiliary winding limiting holes, and the main winding limiting holes and the auxiliary winding limiting holes both penetrate through the top surface and the bottom surface; the main winding limiting hole is used for accommodating the main winding, and the auxiliary winding limiting hole is used for accommodating the auxiliary winding; air gaps are formed between each of the main winding limiting holes and an adjacent auxiliary winding limiting hole; and the first and second main windings and the first and second auxiliary windings are “I” shaped.

4. The two-phase voltage regulator module of claim 1, wherein the magnetic core comprises two winding limiting holes, and each of the winding limiting holes penetrates through the top surface and the bottom surface; and each of the winding limiting holes is used for containing a main winding and an auxiliary winding.

5. The two-phase voltage regulator module of claim 1, wherein the first auxiliary electrical connector and the second auxiliary electrical connector are arranged close to a first side surface of the magnetic core.

6. The two-phase voltage regulator module of claim 5, further comprising: two switch units, wherein SW pins of each of the switch units is disposed adjacent to a first side surface of the two-phase voltage regulator module, and top surface bonding pads of the first main winding and the second main winding are disposed adjacent to the first side surface of the magnetic core;
the two-phase voltage regulator module further comprises a first power electrical connector and two second power electrical connectors, the first power electrical connector is arranged adjacent to the first side surface of the magnetic core, and the two second power electrical connectors are arranged on a second side surface of the magnetic core and a fourth side surface of the magnetic core respectively.

7. The two-phase voltage regulator module of claim 6, wherein the first power electrical connector is arranged between the first auxiliary electrical connector and the second auxiliary electrical connector.

8. The two-phase voltage regulator module of claim 6, wherein the two first power electrical connectors are arranged on two sides of the first auxiliary electrical connector and the second auxiliary electrical connector respectively.

9. The two-phase voltage regulator module of claim 6, further comprising: an input capacitor and other passive elements, wherein the input capacitor is arranged between the two switch units and is arranged adjacent to the first side surface; and the other passive elements are arranged adjacent to the third side surface.

10. The two-phase voltage regulator module of claim 6, further comprising: an input capacitor and other passive elements, wherein the input capacitor is arranged between the two switch units and is arranged adjacent to the third side surface; and the other passive elements are arranged between each the switch units and the input capacitor arranged adjacent to the third side surface.

11. The two-phase voltage regulator module of claim 6, wherein the intermediate assembly further comprises limiting grooves, and the limiting grooves are arranged adjacent to the first side surface, the second side surface and/or the fourth side surface; and the two-phase voltage regulator module is used for accommodating the first power electrical connector, the first auxiliary electronic connector, a second auxiliary electronical connector and a second power electrical connector.

12. The two-phase voltage regulator module of claim 11, wherein the limiting groove is formed in a side surface of one of the first side surface, the second side surface and the fourth side surface.

13. The two-phase voltage regulator module of claim 12, wherein each of the limiting grooves extends from the side surface to the top surface and the bottom surface of the intermediate assembly.

14. The two-phase voltage regulator module of claim 11, wherein the limiting grooves formed in the first side surface are connected together to form a side wall groove; and the first power electrical connector, the first auxiliary electrical connector and the second auxiliary electrical connector are connected into a connector assembly through insulating material.

15. The two-phase voltage regulator module of claim 11, wherein the limiting grooves are formed in the top surface and the bottom surface of the intermediate assembly.

16. The two-phase voltage regulator module of claim 11, wherein the first power electronic connector, the first auxiliary electronic connector, the second auxiliary electronic connector and the second power electrical connector are “C” shaped, “□” shaped or strip-shaped.

17. The two-phase voltage regulator module of claim 11, wherein chamfering treatment is carried out on the limiting groove used for setting the first and second power electrical connectors and an edge of the power electrical connector.

18. The two-phase voltage regulator module of claim 4, wherein the main winding and the auxiliary winding in the same limiting hole have the same width, and a thickness of the main winding is greater than a thickness of the auxiliary winding.

19. The two-phase voltage regulator module of claim 4, wherein the main winding and the auxiliary winding are “I” shaped; sectional areas of the main winding and the auxiliary winding are square; and the main winding and the auxiliary winding are enameled copper flat wires.

20. The two-phase voltage regulator module of claim 4, wherein the main winding and the auxiliary winding are round enameled wires.

21. The two-phase voltage regulator module of claim 4, wherein a glue dispensing hole position is formed in one side of the limiting hole; the glue dispensing hole position extends to a certain depth from the top surface to an inner of the magnetic core; and the glue dispensing hole position is used for arranging a glue material and fixing the main winding, the auxiliary winding and the magnetic core together.

22. The two-phase voltage regulator module of claim 4, wherein a chamfer is arranged on the side, adjacent to the auxiliary winding and the main winding on the top surface and/or the bottom surface of the intermediate assembly.

23. The two-phase voltage regulator module of claim 1, wherein the first main winding and the second main winding are in ”Z” shape; the first auxiliary winding and the second auxiliary winding are “n” shaped; the first ends of the first main winding and the second main winding are arranged close to the first side surface, and the second ends are arranged close to the third side surface; and the first auxiliary winding and the second auxiliary winding are arranged between the first main winding and the second main winding.

24. The two-phase voltage regulator module of claim 23, wherein the first main winding and the second main winding are both formed by bending or stamping enameled insulating copper flat wires.

25. The two-phase voltage regulator module of claim 23, wherein the magnetic core comprises a first magnetic core, a second magnetic core and a third magnetic core; and the first magnetic core and the second magnetic core comprise grooves which are respectively used for limiting the first main winding, the first auxiliary winding, the second main winding and the second auxiliary winding.

26. The two-phase voltage regulator module of claim 25, wherein the first magnetic core and the second magnetic core both comprise limiting grooves used for assembling the second power electrical connector.

27. The two-phase voltage regulator module of claim 23, wherein a first end of the main winding and the auxiliary winding adjacent to the first side surface of the magnetic core exposed in air.

28. The two-phase voltage regulator module of claim 1, wherein a bottom surface of the intermediate assembly comprises a groove or a step for accommodating an output capacitor; and
the output capacitor is electrically connected with the bottom assembly.

29. The two-phase voltage regulator module of claim 1, wherein the magnetic core is integrally formed or assembled; and the magnetic core material can be a powder core or a ferrite material.

30. The two-phase voltage regulator module of claim 1, wherein the bottom assembly comprises top surface pins and bottom surface pins; the top surface pins comprise an input positive pin, a grounding pin, a signal pin, an output positive pin, an auxiliary winding pin and an auxiliary part pin; and the top surface pins of the bottom assemblies are in one-to-one correspondence with and electrically connected with positions of the bottom pins and the bottom surface bonding pads of the intermediate assembly.

31. The two-phase voltage regulator module of claim 30, wherein each of the bottom surface pins comprises a signal pin, an input positive pin, a function extension pin, an output positive pin and a grounding pin; and the output positive pin and the grounding pin are arranged in a staggered mode.

32. The two-phase voltage regulator module of claim 1, further comprising: a vertical plate, wherein the vertical plate is arranged adjacent to the third side surface of the intermediate assembly; the vertical plate comprises a signal electrical connector and a large-area copper layer; and the large-area copper layer is arranged between the signal electrical connector and the magnetic core.

33. The two-phase voltage regulator module of claim 1, wherein the first main winding and the second main winding are not coupled.

34. The two-phase voltage regulator module of claim 1, wherein a coupling between the main winding and the adjacent auxiliary winding is strong coupling.

35. The two-phase voltage regulator module of claim 1, wherein the first/second power electrical connectors and the first/second auxiliary electrical connectors are formed by stamping a copper sheet, electroplating a layer of nickel on the copper sheet and then electroplating a layer of tin.

36. An N-phase voltage regulator module, comprising: N/2 two-phase voltage regulator modules of claim 1, wherein N is an even number; each of the two-phase voltage regulator modules is arranged on the same load mainboard, and the first expansion pins of one two-phase voltage module and the second expansion pins of the other two-phase voltage module are sequentially and electrically connected in series to form an auxiliary winding loop.

37. The N-phase voltage regulation module of claim 36, wherein the auxiliary winding loop further comprises a compensation inductor, and the compensation inductor is connected in series between the first expansion pin of any of the two-phase voltage regulator modules and the second expansion pin of the other two-phase voltage regulator module.

38. A manufacturing process, used for manufacturing an inductor integrated assembly which comprises a magnetic core, a first main winding, a second main winding, a first auxiliary winding, a second auxiliary winding, a power electrical connector and an auxiliary electrical connector, wherein the manufacturing process comprises the following steps:
a step 1, pressing a magnetic powder core material into a magnetic core, wherein the magnetic core comprises a winding positioning hole, a groove or a limiting groove; annealing the magnetic core;
a step 2, carrying out flat wire cutting or stamping on the enameled copper, and manufacturing a main winding and an auxiliary winding; then bonding one main winding and one auxiliary winding with glue;
a step 3, combining the magnetic core formed in the step 1 and the winding combination from the step 2 to form an integrated inductor semi-finished product;
a step 4, performing impregnation treatment on the integrated inductor semi-finished product obtained in the step 3; and
a step 5, grinding the top surface and the bottom surface of the inductor semi-finished product obtained in the step 4, so that the heights of the winding on the top surface and the bottom surface protruding out of the magnetic core are equal.

39. The manufacturing process of claim 38, wherein a surface coating process is carried out on the inductor semi-finished product formed in the step 5; and then the coating.

40. An inductor assembly, comprising: a magnetic core, a first main winding, a second main winding, a first auxiliary winding, a second auxiliary winding, a first auxiliary electrical connector and a second auxiliary electrical connector; wherein the inductor assembly further comprises a top surface and a bottom surface which are opposite to each other, a first side surface and a third side surface which are opposite to each other, and a second side surface and a fourth side surface which are opposite to each other, wherein each side surface is arranged between the top surface and the bottom surface;
the first main winding and the first auxiliary winding are adjacently arranged, and the first main winding and the first auxiliary winding are electrically isolated; the second main winding and the second auxiliary winding are adjacently arranged, and the second main winding and the second auxiliary winding are electrically isolated; the first main winding, the second main winding, the first auxiliary winding and the second auxiliary winding both comprise a top surface bonding pad arranged on the top surface and a bottom surface bonding pad arranged on the bottom surface; and the first auxiliary electrical connector and the second auxiliary electrical connector both comprise a top pin arranged on the top surface and a bottom pin arranged on the bottom surface.

41. The inductor assembly of claim 40, further comprising: a first power electrical connector and two second power electrical connectors, wherein the first power electrical connector is arranged adjacent to the first side surface of the magnetic core, and the two second power electrical connectors are arranged on the second side surface of the magnetic core and the fourth side surface of the magnetic core respectively.

42. The inductor assembly of claim 41, further comprising: a limiting groove, wherein the limiting groove is arranged adjacent to the first side surface, the second side surface and/or the fourth side surface; and the two-phase voltage regulator module is used for accommodating the first power electrical connector, the first auxiliary electronic connector, a second auxiliary electronical connector and a second power electrical connector.

43. The inductor assembly of claim 42, wherein the limiting grooves formed in the first side surface are connected together to form a side wall groove; and the first power electrical connector, the first auxiliary electrical connector and the second auxiliary electrical connector are connected into a connector assembly through insulating material.

44. The inductor assembly of claim 42, wherein chamfering treatment is carried out on the limiting groove used for setting the first and second power electrical connector and the edge of the power electrical connector; a chamfer is arranged on the side, adjacent to the first/second auxiliary winding and the first/second main winding on the top surface and/or the bottom surface of the inductor assembly.

45. The inductor assembly of claim 40, wherein the magnetic core comprises two winding limiting holes, and each of the winding limiting holes penetrates through the top surface and the bottom surface; and each of the winding limiting holes is used for containing a main winding and an auxiliary winding.

46. The inductor assembly of claim 45, wherein the main winding and the auxiliary winding in the same limiting hole have the same width, and a thickness of the main winding is greater than a thickness of the auxiliary winding.

47. The inductor assembly of claim 45, wherein a glue dispensing hole position is formed in one side of the limiting hole; the glue dispensing hole position extends to a certain depth from the top surface to the inner of the magnetic core; and the glue dispensing hole position is used for arranging a glue material and fixing the main winding, the auxiliary winding and the magnetic core together.

48. The inductor assembly of claim 40, wherein the bottom surface of the inductor assembly comprises a groove or a step for accommodating an output capacitor.

49. The inductor assembly of claim 40, wherein the first main winding and the second main winding are in ”Z” shape; the first auxiliary winding and the second auxiliary winding are “n” shaped; the first ends of the first main winding and the second main winding are arranged close to the first side surface, and the second ends are arranged close to the third side surface; and the first auxiliary winding and the second auxiliary winding are arranged between the first main winding and the second main winding.

50. The inductor assembly of claim 40, wherein the main winding and the auxiliary winding are “I” shaped; sectional areas of the main winding and the auxiliary winding are square or circle.
